(19) United States
(12) Patent Application Publication
(10) Pub. No.: US 2025/0242585 A1
(43) Pub. Date: Jul. 31, 2025

(54) LIQUID EJECTING SYSTEM

(71) Applicant: SEIKO EPSON CORPORATION, Tokyo (JP)

(72) Inventors: Hiroaki OKUI, AZUMINO-SHI (JP); Nobuaki ITO, SUWA-SHI (JP)

(21) Appl. No.: 19/038,778

(22) Filed: Jan. 28, 2025

(30) Foreign Application Priority Data
Jan. 30, 2024 (JP) 2024-011738

(51) Int. Cl. B41J 2/045; B41J 2/14; B41J 29/393

(52) U.S. Cl. CPC B41J 2/04588; B41J 2/04581; B41J 2/14233; B41J 29/393

(57) ABSTRACT

A liquid ejecting system includes a liquid ejecting head, a transmission control portion, and a reception control portion. The liquid ejecting head includes a nozzle, a piezoelectric element that is driven by a drive signal being supplied, a diaphragm that vibrates by driving the piezoelectric element, a pressure chamber which is filled with an ink and to which a pressure for ejecting the ink from the nozzle is applied by the vibration of the diaphragm, and a detection circuit that detects residual vibration of the diaphragm after the piezoelectric element is driven.

The transmission control portion transmits residual vibration information indicating the residual vibration detected by the detection circuit to a server. The reception control portion receives adjustment information for adjusting a waveform of the drive signal, which is generated based on the residual vibration indicated by the residual vibration information, from the server.

The present application is based on, and claims priority from JP Application Serial

Number 2024-011738, filed Jan. 30, 2024, the disclosure of which is hereby incorporated by reference herein in its entirety.

### BACKGROUND

### 1. Technical Field

The present disclosure relates to a liquid ejecting system.

### 2. Related Art

A liquid ejecting apparatus that prints an image by causing a nozzle to eject a liquid such as an ink by using a piezoelectric element is known. For example, the liquid ejecting apparatus includes a liquid ejecting head that causes the nozzle to eject the liquid with which a pressure chamber is filled, by vibrating a diaphragm that constitutes a part of the pressure chamber by the piezoelectric element. Here, as a parameter used to determine a waveform of a drive signal for driving the piezoelectric element, a parameter related to a behavior of the ink, such as a natural vibration cycle of the pressure chamber is known. For example, the natural vibration cycle of the pressure chamber is determined by a shape of the pressure chamber or the like, and varies for each liquid ejecting head, caused by assembly accuracy at a time of manufacturing the liquid ejecting head and dimensional accuracy of components. The variation in natural vibration cycle of the pressure chamber is a cause of a variation in ejection characteristics of the liquid.

Therefore, for example, in a method of manufacturing a recording head disclosed in JP-A-2004-351703, a natural vibration cycle is measured for each assembled recording head, and the recording head is classified into any one of a plurality of ranks according to the measured natural vibration cycle. The rank of the natural vibration cycle associated with the recording head is used, for example, to determine a waveform of a drive signal for driving a piezoelectric element.

Meanwhile, a parameter related to a behavior of an ink, such as a natural vibration cycle

of a pressure chamber, varies depending on a manufacturing variation of a liquid ejecting head and also varies depending on a use condition of the liquid ejecting head. For example, the parameter related to the behavior of the ink is also changed depending on an ink condition such as a type of ink. Here, for example, a business model in which a head manufacturer that manufactures a liquid ejecting head sells the liquid ejecting head to a printing apparatus manufacturer, and the printing apparatus manufacturer assembles a liquid ejecting apparatus is considered. In the business model, in many cases, a use condition of the liquid ejecting head such as an ink condition is determined by the printing apparatus manufacturer, not the head manufacturer. When the head manufacturer assembles the liquid ejecting apparatus, the head manufacturer can specify a natural vibration cycle since the head manufacturer also determines the use condition. On the other hand, in the business model described above, there is a concern that the head manufacturer may not be able to appropriately specify a natural vibration cycle at a stage at which the head manufacturer manufactures and sells the liquid ejecting head. In that case, it is difficult for the head manufacturer to determine a waveform of an appropriate drive signal in accordance with a natural vibration cycle. Therefore, in the business model described above, the printing apparatus manufacturer needs to determine the waveform of the appropriate drive signal in accordance with the natural vibration cycle, and there is a concern that this may cause an excessive load on the printing apparatus manufacturer. Therefore, in the business model described above, it is desired to be able to appropriately and easily determine the waveform of the drive signal for driving a piezoelectric element. Even when a manufacturer of the liquid ejecting apparatus and a manufacturer of the liquid ejecting head have the same business model, it is desirable, although to a relatively small extent, to be able to appropriately and easily determine the waveform of the drive signal for driving the piezoelectric element. It is conceivable that a user sets a use condition different from a use condition assumed in advance by the manufacturer of the liquid ejecting head or the liquid ejecting apparatus, and in this case, the same problem occurs.

### SUMMARY

According to an aspect of the present disclosure, there is provided a liquid ejecting system including: a liquid ejecting head; a transmission control portion; and a reception control portion, in which the liquid ejecting head includes a nozzle, a piezoelectric element that is driven by a drive signal being supplied, a diaphragm that vibrates by driving the piezoelectric element, a pressure chamber which is filled with a liquid and to which a pressure for ejecting the liquid from the nozzle is applied by the vibration of the diaphragm, and a detection portion that detects residual vibration of the diaphragm after the piezoelectric element is driven, the transmission control portion transmits residual vibration information indicating the residual vibration detected by the detection portion to a server, and the reception control portion receives adjustment information for adjusting a waveform of the drive signal, which is generated based on the residual vibration indicated by the residual vibration information, from the server.

### BRIEF DESCRIPTION OF THE DRAWINGS

FIG. 1 is a block diagram illustrating an example of a configuration of a liquid ejecting system according to an embodiment of the present disclosure.

FIG. 2 is a diagram illustrating an example of a configuration of a server.

FIG. 3 is a configuration diagram schematically illustrating a liquid ejecting apparatus.

FIG. 4 is an exploded perspective view of a liquid ejecting head.

FIG. 5 is a cross-sectional diagram taken along a line V-V in FIG. 4.

FIG. 6 is a block diagram illustrating an example of a configuration of the liquid ejecting head.

FIG. 7 is a timing chart illustrating an example of an operation of the liquid ejecting apparatus in a unit period.

FIG. 8 is a diagram describing adjustment information for adjusting a waveform of a drive signal.

FIG. 9 is a diagram illustrating an example of a waveform of a residual vibration signal.

FIG. 10 is a diagram describing a difference in waveform of the residual vibration signal depending on a use condition of the liquid ejecting head.

FIG. 11 is a diagram illustrating an example of an operation of the liquid ejecting system when adjusting the waveform of the drive signal.

FIG. 12 is a diagram illustrating another example of the operation of the liquid ejecting system when adjusting the waveform of the drive signal.

### DESCRIPTION OF EMBODIMENTS

Hereinafter, embodiments for carrying out the present disclosure will be described with reference to the drawings. Meanwhile, in each drawing, the size and scale of each portion are appropriately different from the actual ones. The embodiments described below are preferred specific examples of the present disclosure and are thus added with technically preferred various limitations, but the scope of the present disclosure is not limited to such embodiments unless description for limiting the present disclosure is made in the following description.

### 1. Embodiment

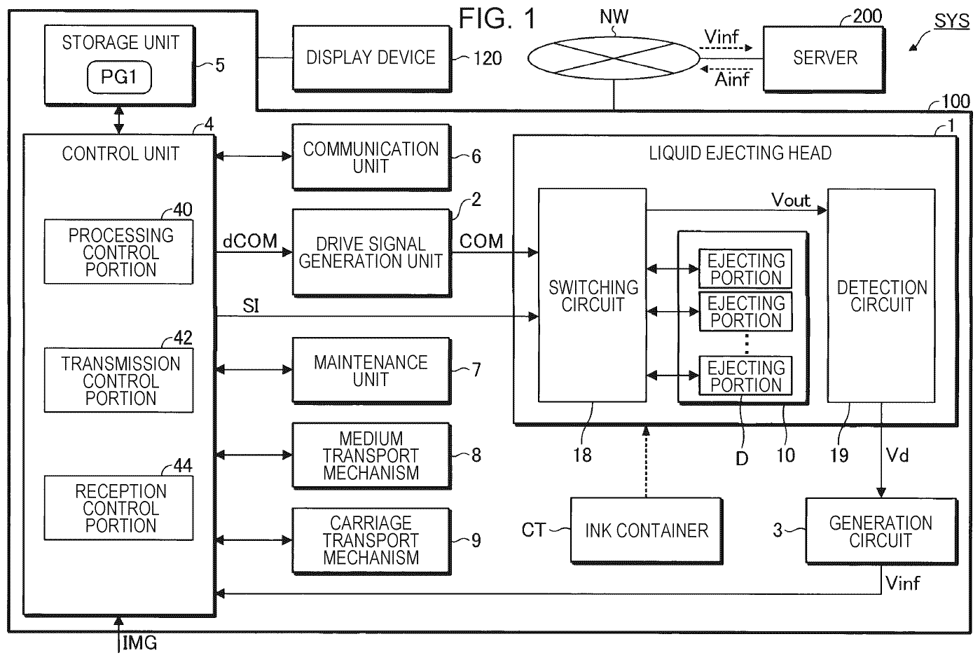

First, an outline of a liquid ejecting system SYS according to the present embodiment will be described with reference to FIG. 1. In the present embodiment, a case is assumed in which a liquid ejecting apparatus 100 included in the liquid ejecting system SYS is an ink jet printer that ejects an ink to a medium PP to form an image. In the present embodiment, a recording paper illustrated in FIG. 3 to be described below is assumed as the medium PP.

FIG. 1 is a block diagram illustrating an example of a configuration of the liquid ejecting system SYS according to an embodiment of the present disclosure. The liquid ejecting system SYS includes, for example, a liquid ejecting apparatus 100, a display device 120, and a server 200 that is communicably connected to the liquid ejecting apparatus 100. The liquid ejecting system SYS may be defined without including one or both of the display device 120 and the server 200.

For example, print data IMG indicating an image to be formed by the liquid ejecting apparatus 100 is supplied to the liquid ejecting apparatus 100 from a host computer such as a personal computer or a digital camera. The liquid ejecting apparatus 100 executes a printing process of forming the image indicated by the print data IMG supplied from the host computer on the medium PP.

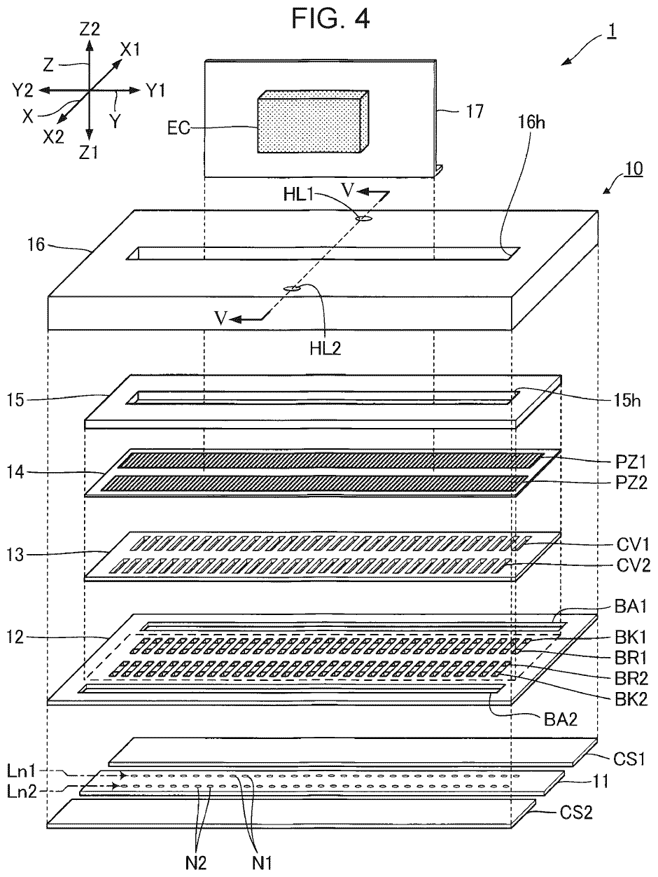

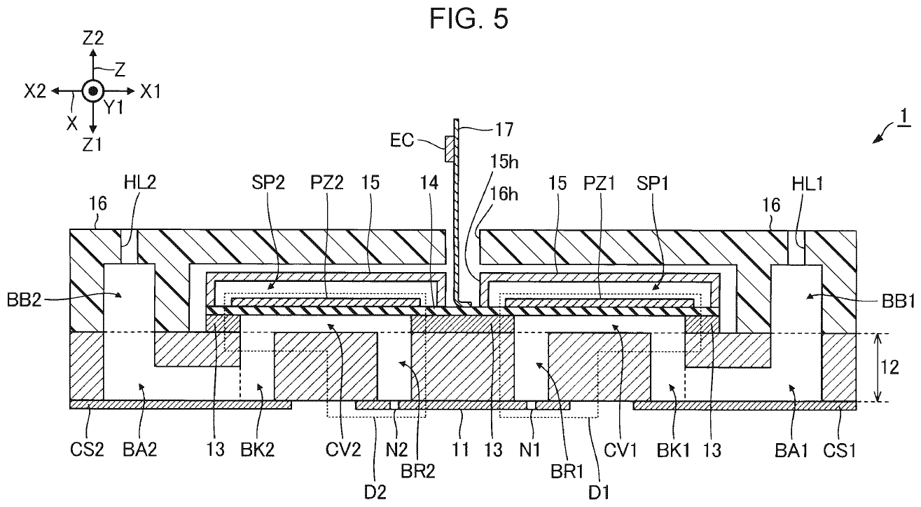

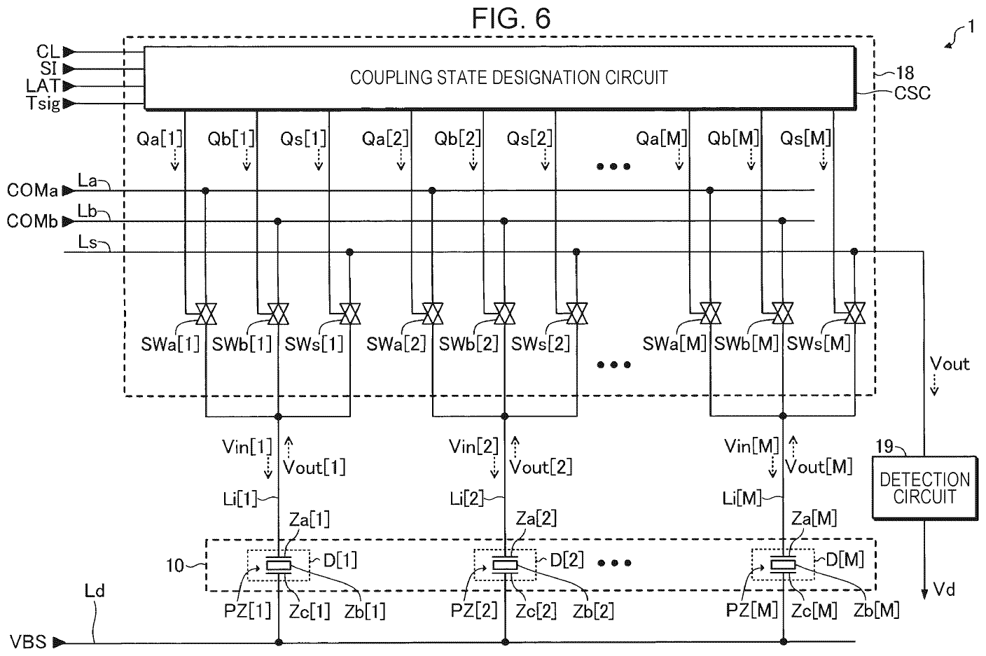

The liquid ejecting apparatus 100 includes a liquid ejecting head 1 provided with an ejecting portion D including a nozzle N that ejects inks, a drive signal generation unit 2 that generates a plurality of drive signals COM for driving the ejecting portion D, and a generation circuit 3 that generates residual vibration information Vinf to be described below. The nozzle N will be described below with reference to FIGS. 4 and 5. Further, the liquid ejecting apparatus 100 includes a control unit 4 that controls each portion of the liquid ejecting apparatus 100, a storage unit 5 that stores various types of information such as the print data IMG and a control program PG 1 of the liquid ejecting apparatus 100, and a communication unit 6 that communicates with another apparatus. Further, the liquid ejecting apparatus 100 includes a maintenance unit 7 that executes a maintenance process of the liquid ejecting head 1, a medium transport mechanism 8 that transports the medium PP, a carriage transport mechanism 9 that reciprocates a carriage 91, and an ink container CT that stores the inks. The carriage 91 will be described below with reference to FIG. 3. The ink is an example of a “liquid”.

In the present embodiment, a case is assumed in which the liquid ejecting head 1 and the drive signal generation unit 2 correspond to each other, and the liquid ejecting head 1 and the generation circuit 3 correspond to each other. For example, the liquid ejecting apparatus 100 may include a plurality of liquid ejecting heads 1, a plurality of drive signal generation units 2, and a plurality of generation circuits 3. In this case, for example, the plurality of drive signal generation units 2 correspond to the plurality of liquid ejecting heads 1 on a one-to-one basis, and the plurality of generation circuits 3 correspond to the plurality of liquid ejecting heads 1 on a one-to-one basis. Alternatively, the liquid ejecting apparatus 100 may include one liquid ejecting head 1, one drive signal generation unit 2 corresponding to the liquid ejecting head 1, and one generation circuit 3 corresponding to the liquid ejecting head 1.

In the present embodiment, a case is assumed in which the liquid ejecting apparatus 100 has four liquid ejecting heads 1 respectively corresponding to four types of inks of cyan, magenta, yellow, and black. That is, in the present embodiment, a case is assumed in which the liquid ejecting apparatus 100 includes four liquid ejecting heads 1, four drive signal generation units 2, and four generation circuits 3. Meanwhile, in the following, for convenience of description, as illustrated in FIG. 1, there may be a case where one liquid ejecting head 1 of the four liquid ejecting heads 1 and one drive signal generation unit 2 corresponding to the one liquid ejecting head 1 are focused on and described.

First, the control unit 4, the drive signal generation unit 2, the storage unit 5, and the communication unit 6 will be described before the liquid ejecting head 1 is described.

The control unit 4 is configured with one or a plurality of central processing units (CPU). The control unit 4 may be configured with a programmable logic device such as a field-programmable gate array (FPGA), instead of the CPU or in addition to the CPU. Further, for example, the control unit 4 generates a signal for controlling an operation of each portion of the liquid ejecting apparatus 100, such as a print signal SI and a waveform designation signal dCOM, by operating according to the control program PG1 stored in the storage unit 5.

Here, the waveform designation signal dCOM is a digital signal that defines each of waveforms of the plurality of drive signals COM. In addition, each drive signal COM is an analog signal used to drive the ejecting portion D. In the present embodiment, as illustrated in FIG. 6 and the like to be described below, it is assumed that the plurality of drive signals COM include drive signals COMa and COMb. The print signal SI is a digital signal for designating a type of operation of the ejecting portion D. Specifically, the print signal SI is a signal for designating the type of operation of the ejecting portion D by designating whether or not to supply each drive signal COM to the ejecting portion D.

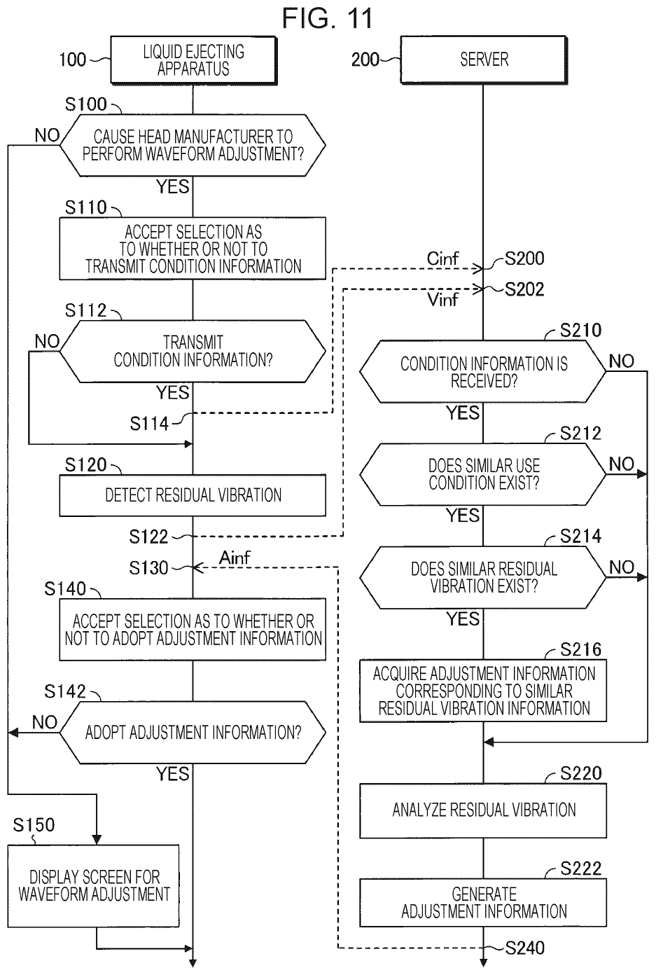

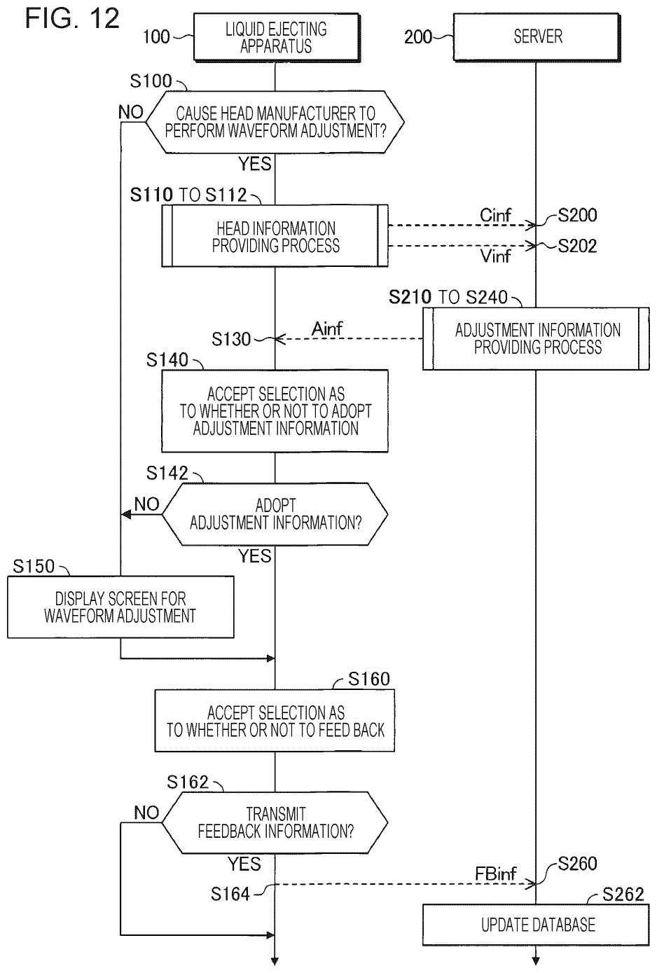

In the present embodiment, the control unit 4 functions as a processing control portion 40, a transmission control portion 42, and a reception control portion 44, by operating according to the control program PG1 stored in the storage unit 5. The processing control portion 40 is an example of an “acceptance portion”. The processing control portion 40, the transmission control portion 42, and the reception control portion 44 execute a process of adjusting a waveform of the drive signal COM, for example. For example, the transmission control portion 42 transmits the residual vibration information Vinf generated by the generation circuit 3 to the server 200 via the communication unit 6. Further, for example, the reception control portion 44 receives adjustment information Ainf for adjusting the waveform of the drive signal COM from the server 200 via the communication unit 6. Details of the operations of the processing control portion 40, the transmission control portion 42, and the reception control portion 44 will be described with reference to FIGS. 11 and 12.

The drive signal generation unit 2 includes, for example, a digital analog converter (DAC), and generates the plurality of drive signals COM based on the waveform designation signal dCOM supplied from the control unit 4. For example, each of the plurality of drive signals COM generated by the drive signal generation unit 2 includes a waveform defined by the waveform designation signal dCOM. The drive signal generation unit 2 outputs the plurality of drive signals COM generated based on the waveform designation signal dCOM to a switching circuit 18 included in the liquid ejecting head 1. The waveform defined by the waveform designation signal dCOM is, for example, a waveform adjusted based on the adjustment information Ainf.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 4.

The communication unit 6 is hardware for performing communication with another apparatus such as the server 200. For example, the communication unit 6 communicates with the server 200 via a network NW such as a local area network (LAN), a wide area network (WAN), and the Internet under the control of the control unit 4. The communication unit 6 is also referred to as a network device, a network controller, a network card, or a communication module, for example.

The liquid ejecting head 1 includes the switching circuit 18, a recording head 10, and a detection circuit 19. The detection circuit 19 is an example of a “detection portion”.

The recording head 10 includes M ejecting portions D. In the present embodiment, a case is assumed in which the value M is an even number equal to or more than 2. In the following, among the M ejecting portions D provided in the recording head 10, an m-th ejecting portion D may be referred to as an ejecting portion D[m]. In this case, the variable m is a natural number that satisfies “1≤m≤M”. Further, in the following, when a component, a signal, or the like of the liquid ejecting apparatus 100 corresponds to the ejecting portion D[m] among the M ejecting portions D, the subscript [m] may be added to the reference numerals for representing the component, the signals, or the like.

The switching circuit 18 switches whether or not to supply each drive signal COM to the ejecting portion D[m], based on the print signal SI. In the following, as illustrated in FIG. 6 and the like to be described below, the drive signal COM supplied to the ejecting portion D[m] among the plurality of drive signals COM may be referred to as an individual drive signal Vin[m]. Further, the switching circuit 18 switches whether or not to electrically couple the ejecting portion D[m] and the detection circuit 19 based on the print signal SI. When the ejecting portion D[m] and the detection circuit 19 are electrically coupled to each other, for example, a detection signal Vout[m] detected from the ejecting portion D[m] is supplied to the detection circuit 19 via the switching circuit 18. The detection signal Vout[m] is, for example, an analog signal indicating a waveform of residual vibration, which is vibration remaining in the ejecting portion D[m] after the ejecting portion D[m] is driven by the individual drive signal Vin[m]. Specifically, for example, the detection signal Vout[m] indicates a waveform of residual vibration of a diaphragm 14 after the piezoelectric element PZ[m] is driven. The piezoelectric element PZ and the diaphragm 14 will be described below with reference to FIGS. 4 and 5.

The detection circuit 19 generates a residual vibration signal Vd[m] based on the detection signal Vout[m]. For example, the detection circuit 19 amplifies an amplitude of the detection signal Vout[m] or removes a noise component included in the detection signal Vout[m] to shape the detection signal Vout[m] into a waveform appropriate for a process in the generation circuit 3. Therefore, the residual vibration signal Vd[m] is generated. For example, the detection circuit 19 may have a configuration including a negative feedback type amplifier for amplifying the detection signal Vout[m], a low-pass filter for attenuating a high-frequency component of the detection signal Vout[m], and a voltage follower that converts an impedance and outputs the residual vibration signal Vd[m] having a low impedance.

For example, the residual vibration signal Vd[m] generated based on the detection signal Vout[m] is an analog signal indicating a waveform of residual vibration of the diaphragm 14 after the piezoelectric element PZ[m] is driven by the individual drive signal Vin[m]. The detection circuit 19 outputs the residual vibration signal Vd[m] generated based on the detection signal Vout[m] to the generation circuit 3. In this manner, the detection circuit 19 detects the residual vibration of the diaphragm 14 after the piezoelectric element PZ[m] is driven, based on the detection signal Vout[m].

The generation circuit 3 includes, for example, an analog to digital converter (ADC), and converts the analog residual vibration signal Vd[m] into a digital signal. For example, the generation circuit 3 generates the residual vibration information Vinf by converting the analog residual vibration signal Vd[m] into the digital signal. The residual vibration information Vinf is, for example, a digital signal indicating the waveform of the residual vibration of the diaphragm 14 after the piezoelectric element PZ[m] is driven. The generation circuit 3 outputs the residual vibration information Vinf generated by converting the analog residual vibration signal Vd[m] into the digital signal, to the control unit 4. The generation circuit 3 may be included in the control unit 4. For example, when the control unit 4 includes the ADC, the control unit 4 may function as the generation circuit 3 by operating according to the control program PG1 stored in the storage unit 5.

Further, in the present embodiment, as described above, the maintenance process is executed by the maintenance unit 7. For example, the maintenance unit 7 executes the maintenance process under the control of the control unit 4. For example, the maintenance process includes flushing processing of discharging inks from the ejecting portion D, wiping processing of wiping off a foreign matter such as an ink adhering to the vicinity of a nozzle N of the ejecting portion D with a wiper, and pumping processing of suctioning the ink in the ejecting portion D with a tube pump or the like.

The maintenance unit 7 includes a discharge ink receiving portion for receiving the discharged ink when the ink in the ejecting portion D is discharged, a wiper for wiping off a foreign matter such as an ink adhering to the vicinity of the nozzle N of the ejecting portion D, and a tube pump for suctioning the ink, air bubbles, and the like in the ejecting portion D, in the flushing processing. The discharge ink receiving portion, the wiper, and the tube pump are not illustrated.

The display device 120 is an output device such as a display that performs an output to an outside, and is communicably connected to the liquid ejecting apparatus 100. For example, the display device 120 displays an image under the control of the control unit 4. The display device 120 may be included in the liquid ejecting apparatus 100. Further, the display device 120 may also function as an input device that accepts an input from the outside. For example, a touch panel display in which an input device and an output device are integrated may be adopted as the display device 120.

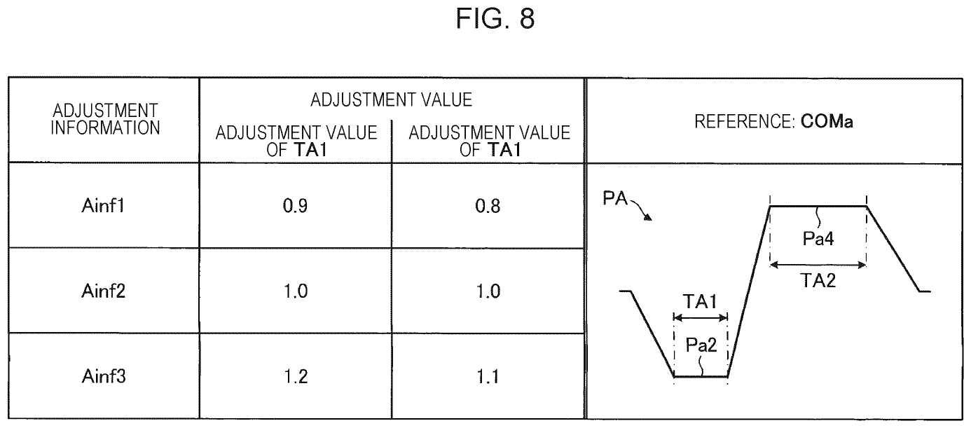

The server 200 is, for example, any information processing apparatus that can communicate with another apparatus. For example, the server 200 receives the residual vibration information Vinf, which is a digital signal indicating the waveform of the residual vibration of the diaphragm 14, from the liquid ejecting apparatus 100 via the network NW. The server 200 analyzes the residual vibration indicated by the residual vibration information Vinf, and generates the adjustment information Ainf for adjusting the waveform of the drive signal COM based on an analysis result of the residual vibration. Further, the server 200 transmits the adjustment information Ainf to the liquid ejecting apparatus 100 via the network NW. The adjustment information Ainf indicates, for example, an adjustment value for adjusting the waveform of the drive signal COM, as illustrated in FIG. 8 to be described below.

In the present embodiment, it is assumed that the server 200 executes the analysis on the residual vibration and the determination of the adjustment value indicated by the adjustment information Ainf. Meanwhile, the analysis of the residual vibration and the determination of the adjustment value indicated by the adjustment information Ainf may not be executed by the server 200. For example, a user or the like of the server 200 may perform the analysis on the residual vibration and the determination of the adjustment value indicated by the adjustment information Ainf. In this case, the server 200 acquires the adjustment information Ainf indicating the adjustment value determined by the user or the like of the server 200, and transmits the acquired adjustment information Ainf to the liquid ejecting apparatus 100 via the network NW. For example, an employee of a head manufacturer that manufactures the liquid ejecting head 1 corresponds to the user of the server 200. The head manufacturer that manufactures the liquid ejecting head 1 may be regarded as the user of the server 200. In addition, an analysis method of the residual vibration is not particularly limited, and a known method can be adopted.

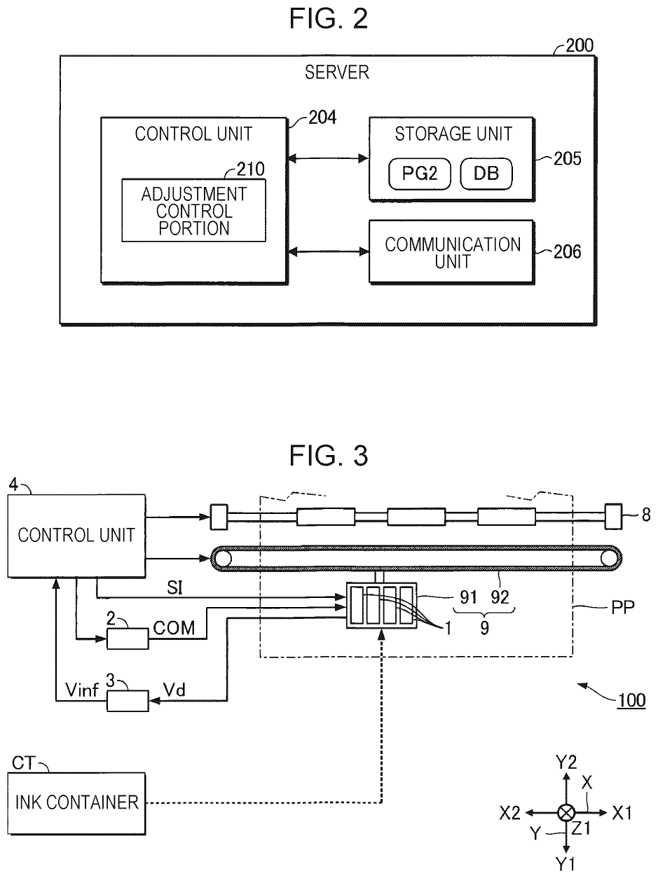

Next, an overall configuration of the server 200 will be described with reference to FIG. 2.

FIG. 2 is a diagram illustrating an example of a configuration of the server 200.

The server 200 includes, for example, a control unit 204 that controls the entire server 200, a storage unit 205 that stores various types of information such as a control program PG2 of the server 200, and a communication unit 206 that communicates with another apparatus.

The control unit 204 is configured in the same manner as the control unit 4 of the liquid ejecting apparatus 100 described in FIG. 1, for example. For example, the control unit 204 includes one or a plurality of CPUs. The control unit 204 may be configured to include a programmable logic device such as an FPGA, in addition to or instead of the CPU. The control unit 204 functions as a control portion that controls the storage unit 205, the communication unit 206, and the like by operating according to, for example, the control program PG2 stored in the storage unit 205. Further, in the present embodiment, the control unit 204 functions as an adjustment control portion 210 for transmitting the adjustment information Ainf to the liquid ejecting apparatus 100 by operating according to the control program PG2. Details of the operation of the adjustment control portion 210 will be described with reference to FIGS. 11 and 12.

The storage unit 205 is configured in the same manner as the storage unit 5 of the liquid ejecting apparatus 100 described in FIG. 1, for example. For example, the storage unit 205 is configured to include one or both of a volatile memory such as a RAM and a non-volatile memory such as a ROM, an EEPROM, or a PROM. The storage unit 205 may be included in the control unit 204. In the present embodiment, the storage unit 205 also stores a database DB, in addition to the control program PG2. The database DB stores, for example, an adoption result of the adjustment information Ainf or the like in association with the adjustment information Ainf.

The database DB may be stored in an external storage unit that is communicably connected to the server 200. The database DB is an example of a “storage portion”. The storage unit 5 storing the database DB may be regarded as the “storage portion”.

The communication unit 206 is configured in the same manner as the communication unit 6 of the liquid ejecting apparatus 100 described in FIG. 1, for example. For example, the communication unit 206 is hardware for performing communication with another apparatus such as the liquid ejecting apparatus 100. For example, the communication unit 206 communicates with the liquid ejecting apparatus 100 via the network NW under the control of the control unit 204.

The configuration of the server 200 is not limited to the example illustrated in FIG. 2. For example, the server 200 may have one or both of an input device such as a keyboard that accepts an input from an outside and an output device such as a display that outputs to the outside.

Next, a schematic overall configuration of the liquid ejecting apparatus 100 will be described with reference to FIG. 3.

FIG. 3 is a configuration diagram schematically illustrating the liquid ejecting apparatus 100. In FIG. 3, the ink container CT, the medium transport mechanism 8, and the carriage transport mechanism 9 will be mainly described.

The ink container CT stores inks. As the ink container CT, for example, a cartridge that can be attached to and detached from the liquid ejecting apparatus 100, a bag-shaped ink pack formed with a flexible film, or an ink tank that can be replenished with inks can be adopted. The type of the ink stored in the ink container CT is not particularly limited, and is optional. In the present embodiment, as described above, a case is assumed in which the liquid ejecting apparatus 100 includes four liquid ejecting heads 1 respectively corresponding to four types of inks of cyan, magenta, yellow, and black. Therefore, in the present embodiment, the ink container CT stores four types of inks of cyan, magenta, yellow, and black. Further, the ink container CT supplies the stored ink to the liquid ejecting head 1.

The medium transport mechanism 8 transports the medium PP in a Y1 direction along a Y-axis under the control of the control unit 4. In the following, the Y1 direction and a Y2 direction opposite to the Y1 direction are collectively referred to as a Y-axis direction. In addition, in the following, an X1 direction along an X-axis that intersects the Y-axis and an X2 direction opposite to the X1 direction are collectively referred to as an X-axis direction. In addition, in the following, a Z1 direction along a Z-axis that intersects the X-axis and the Y-axis and a Z2 direction opposite to the Z1 direction are collectively referred to as a Z-axis direction. In the present embodiment, as an example, description will be performed by assuming that the X-axis, the Y-axis, and the Z-axis are orthogonal to each other. Meanwhile, the present disclosure is not limited to such an aspect. The X-axis, the Y-axis, and the Z-axis may intersect each other.

The carriage transport mechanism 9 reciprocates the plurality of liquid ejecting heads 1 in the X1 direction and the X2 direction under the control of the control unit 4. As illustrated in

FIG. 3, the carriage transport mechanism 9 includes the substantially box-shaped carriage 91 that accommodates the plurality of liquid ejecting heads 1, and an endless belt 92 to which the carriage 91 is fixed. The ink container CT may be stored in the carriage 91 together with the liquid ejecting head 1.

The liquid ejecting head 1 is driven by the drive signal COM under the control of the print signal SI, and ejects the ink in the Z1 direction from some or all of a plurality of nozzles N provided in the liquid ejecting head 1. That is, the liquid ejecting head 1 forms a desired image on a surface of the medium PP by ejecting the ink from the some or all of the plurality of nozzles N in conjunction with transport of the medium PP by the medium transport mechanism 8 and a reciprocating motion of the liquid ejecting head 1 by the carriage transport mechanism 9 and landing the ejected ink on the surface of the medium PP. In the present embodiment, as described above, the Z1 direction is a direction in which an ink is ejected from the nozzle N.

Next, a schematic structure of the liquid ejecting head 1 will be described with reference to FIGS. 4 and 5.

FIG. 4 is an exploded perspective view of the liquid ejecting head 1. FIG. 5 is a cross-sectional diagram taken along a line V-V in FIG. 4. A cross section of the line V-V is parallel to the XZ plane and passes through inlets HL1 and HL2, which will be described below. In FIGS. 4 and 5, in order to distinguish two nozzle rows Ln from each other, which will be described below, an end of a reference sign of a nozzle row Ln is added with a number “1” or “2”. In addition, in FIGS. 4 and 5, in order to facilitate the description, the number “1” is added to the end of the reference sign of the nozzle N included in a nozzle row Ln1, and the number “2” is added to the end of the reference sign of the nozzle N included in a nozzle row Ln2.

As illustrated in FIGS. 4 and 5, the liquid ejecting head 1 includes a nozzle substrate 11, compliance sheets CS1 and CS2, a communication plate 12, a pressure chamber substrate 13, the diaphragm 14, a sealing substrate 15, a flow path forming substrate 16, and a wiring substrate 17 at which an electronic component EC is mounted. The electronic component EC includes, for example, an electric circuit such as the switching circuit 18 and the detection circuit 19. For example, the recording head 10 is electrically coupled to the switching circuit 18, the detection circuit 19, and the like via the wiring substrate 17.

As illustrated in FIG. 4, the recording head 10 includes, for example, the nozzle substrate 11, the compliance sheets CS1 and CS2, the communication plate 12, the pressure chamber substrate 13, the diaphragm 14, the sealing substrate 15, and the flow path forming substrate 16. The nozzle substrate 11 is a plate-shaped member elongated in the Y-axis direction and extending substantially parallel to an XY plane. Here, “substantially parallel” is a concept that includes not only a case of being completely parallel but also a case of being considered to be parallel when an error is considered. In the present embodiment, “substantially parallel” is a concept that includes a case where it can be regarded as parallel when an error of approximately 10% is considered. The “substantially vertical” described below is also a concept that includes a case where it is considered to be vertical when an error is taken into consideration, in addition to a case where it is completely vertical, as in the case of the “substantially parallel”. The nozzle substrate 11 is manufactured, for example, by processing a silicon single crystal substrate using a semiconductor manufacturing technology such as etching, and any known material and manufacturing method may be adopted to manufacture the nozzle substrate 11.

M nozzles N are formed at the nozzle substrate 11. Here, the nozzle N is a through-hole provided in the nozzle substrate 11. In the present embodiment, a case is assumed in which the plurality of nozzles N formed in the nozzle substrate 11 include a plurality of nozzles N1 arranged to extend in the Y-axis direction, and a plurality of nozzles N2 arranged to extend in the Y-axis direction at a position in the X2 direction when viewed from the plurality of nozzles N1. In the following, the plurality of nozzles N1 extending in the Y-axis direction are referred to as the nozzle row Ln1, and the plurality of nozzles N2 extending in the Y-axis direction are referred to as the nozzle row Ln2. For example, the number of nozzles N included in each of the nozzle rows LN1 and Ln2 is half the value M. In the following, the nozzle row Ln1 and the nozzle row Ln2 may be collectively referred to as a nozzle row Ln. In addition, in FIGS. 4 and 5, in order to facilitate the description, in the liquid ejecting head 1, a number “1” is added to an end of a reference sign of a component corresponding to the nozzle row Ln1, and a number “2” is added to an end of a reference sign of a component corresponding to the nozzle row Ln2.

As illustrated in FIGS. 4 and 5, the communication plate 12 is provided at a position in the Z2 direction when viewed from the nozzle substrate 11. The communication plate 12 is a plate-shaped member elongated in the Y-axis direction and extending substantially parallel to the

XY plane. The communication plate 12 is manufactured, for example, by processing a silicon single crystal substrate using semiconductor manufacturing technology, and any known material and manufacturing method may be adopted to manufacture the communication plate 12.

A flow path for inks is formed in the communication plate 12. Specifically, the communication plate 12 is formed with one supply flow path BAI provided to extend in the Y-axis direction, and one supply flow path BA2 provided to extend in the Y-axis direction at a position in the X2 direction when viewed from the supply flow path BA1. In addition, the communication plate 12 is formed with a plurality of coupling flow paths BK1 corresponding to the plurality of nozzles N1, a plurality of coupling flow paths BK2 corresponding to the plurality of nozzles N2, a plurality of communication flow paths BR1 corresponding to the plurality of nozzles N1, and a plurality of communication flow paths BR2 corresponding to the plurality of nozzles N2.

As illustrated in FIG. 5, the coupling flow path BK1 is provided to communicate with the supply flow path BA1 and extend in the Z-axis direction at a position in the X2 direction when viewed from the supply flow path BA1. The communication flow path BR1 is provided to extend in the Z-axis direction at a position in the X2 direction when viewed from the coupling flow path BK1. The communication flow path BR1 communicates with the nozzle N1 corresponding to the communication flow path BR1. The coupling flow path BK2 is provided to communicate with the supply flow path BA2 and extend in the Z-axis direction at a position in the X1 direction when viewed from the supply flow path BA2. The communication flow path BR2 is provided to extend in the Z-axis direction at a position, which is a position in the X1 direction when viewed from the coupling flow path BK2 and in the X2 direction when viewed from the communication flow path BR1. The communication flow path BR2 communicates with the nozzle N2 corresponding to the communication flow path BR2.

The supply flow paths BA1 and BA2 are also referred to as a supply flow path BA without particular distinction, the coupling flow paths BK1 and BK2 are also referred to as a coupling flow path BK without particular distinction, and the communication flow paths BR1 and BR2 are also referred to as a communication flow path BR without particular distinction.

As illustrated in FIGS. 4 and 5, the pressure chamber substrate 13 is provided at a position in the Z2 direction when viewed from the communication plate 12. The pressure chamber substrate 13 is a plate-shaped member elongated in the Y-axis direction and extending substantially parallel to the XY plane. The pressure chamber substrate 13 is manufactured, for example, by processing a silicon single crystal substrate using semiconductor manufacturing technology, and any known material and manufacturing method may be adopted to manufacture the pressure chamber substrate 13.

A flow path for inks is formed in the pressure chamber substrate 13. Specifically, the pressure chamber substrate 13 is formed with a plurality of pressure chambers CV1 corresponding to the plurality of nozzles N1 and a plurality of pressure chambers CV2 corresponding to the plurality of nozzles N2. Of these, the pressure chamber CVI is provided to couple an end portion of the coupling flow path BK1 in the X2 direction and an end portion of the communication flow path BR1 in the X1 direction when viewed in the Z-axis direction, and extend in the X-axis direction. When viewed in the Z-axis direction, the pressure chamber CV2 is provided to couple an end portion of the coupling flow path BK2 in the X1 direction and an end portion of the communication flow path BR2 in the X2 direction, and extend in the X-axis direction. The pressure chambers CV1 and CV2 are also referred to as a pressure chamber CV without particular distinction.

As illustrated in FIGS. 4 and 5, the diaphragm 14 is provided at a position in the Z2 direction when viewed from the pressure chamber substrate 13. The diaphragm 14 is a plate-shaped member elongated in the Y-axis direction and extending substantially parallel to the XY plane, and is a member that can vibrate elastically. In the present embodiment, the diaphragm 14 has, for example, an elastic layer made of silicon oxide and an insulating layer made of zirconium oxide provided at a position in the Z2 direction when viewed from the elastic layer. That is, in the present embodiment, a surface of the diaphragm 14 in the Z2 direction is formed with a non-conductive member. Here, a surface of an element A in a first direction is a surface of the element A, which is substantially perpendicular to the first direction among surfaces of the element A, and is a surface which is visible when the element A is viewed in the first direction from a second direction. The second direction is a direction opposite to the first direction. The elastic layer of the diaphragm 14 is not limited to the elastic layer made of silicon oxide. In the same manner, the insulating layer of the diaphragm 14 is not limited to the insulating layer made of zirconium oxide.

As illustrated in FIGS. 4 and 5, a plurality of piezoelectric elements PZ1 corresponding to the plurality of pressure chambers CV1 and a plurality of piezoelectric elements PZ2 corresponding to the plurality of pressure chambers CV2 are provided at a position in the Z2 direction when viewed from the diaphragm 14. The piezoelectric elements PZ1 and PZ2 are also referred to as a piezoelectric element PZ without particular distinction. The piezoelectric element PZ is driven by the drive signal COM being supplied.

Although not illustrated in FIGS. 4 and 5, the piezoelectric element PZ has a common electrode Zc to which a predetermined bias potential VBS is supplied, an individual electrode Za to which the individual drive signal Vin is supplied, and a piezoelectric body Zb provided between the individual electrode Za and the common electrode Zc, as illustrated in FIG. 6. For example, the individual electrode Za, the piezoelectric body Zb, and the common electrode Zc are provided in this order along the Z2 direction on the surface of the diaphragm 14 in the Z2 direction. Here, an expression “an element B is formed at the surface of the element A” in the present specification is not intended to limit the configuration to a configuration in which the element A and the element B are in direct contact with each other. That is, a configuration in which an element C is formed at the surface of the element A and the element B is formed at a surface of the element C is also included in the concept of “the element B is formed at the surface of the element A” insofar as the element A and the element B overlap at least in part in plan view.

In the present embodiment, the common electrode Zc is a so-called upper electrode, and the individual electrode Za is a so-called lower electrode, and the common electrode Zc may be a lower electrode and the individual electrode Za may be an upper electrode.

The piezoelectric element PZ is a passive element that is deformed in response to a potential change of the drive signal COM supplied to the individual electrode Za as the individual drive signal Vin. In other words, the piezoelectric element PZ is an example of an energy conversion element that converts the electric energy of the drive signal COM into kinetic energy. Specifically, the piezoelectric element PZ is driven and deformed in response to a potential change of the drive signal COM.

As illustrated in FIGS. 4 and 5, since the piezoelectric element PZ is provided on the surface of the diaphragm 14 in the Z2 direction, the diaphragm 14 vibrates in conjunction with the deformation of the piezoelectric element PZ. That is, the diaphragm 14 vibrates by driving the piezoelectric element PZ. When the diaphragm 14 vibrates, a pressure in the pressure chamber CV fluctuates. Then, the pressure inside the pressure chamber CV fluctuates, and an ink with which an inside of the pressure chamber CV is filled is ejected from the nozzle N via the communication flow path BR. In this manner, the pressure chamber CV is filled with the ink, and a pressure for ejecting the ink from the nozzle N is applied by the vibration of the diaphragm 14. In addition, the vibration remaining in the ejecting portion D[m] described in FIG. 1 can be regarded as, for example, vibration remaining in the ink in the pressure chamber CV of the ejecting portion D.

As illustrated in FIGS. 4 and 5, the sealing substrate 15 for protecting the plurality of piezoelectric elements PZ1 and the plurality of piezoelectric elements PZ2 is provided at a position in the Z2 direction when viewed from the pressure chamber substrate 13. The sealing substrate 15 is a plate-shaped member elongated in the Y-axis direction and extending substantially parallel to the XY plane. The sealing substrate 15 is manufactured, for example, by processing a silicon single crystal substrate using semiconductor manufacturing technology, and any known material and manufacturing method may be adopted to manufacture the sealing substrate 15.

As illustrated in FIG. 5, a surface of the sealing substrate 15 in the Z1 direction is provided with a recess portion for covering the plurality of piezoelectric elements PZ1 and a recess portion for covering the plurality of piezoelectric elements PZ2. In the following, a sealing space covering the plurality of piezoelectric elements PZ1 and formed between the diaphragm 14 and the sealing substrate 15 is referred to as a sealing space SP1, and a sealing space covering the plurality of piezoelectric elements PZ2 and formed between the diaphragm 14 and the sealing substrate 15 is referred to as a sealing space SP2. Further, the sealing spaces SP1 and SP2 are also referred to as a sealing space SP without particular distinction. The sealing space SP is a space for sealing the piezoelectric element PZ and preventing the piezoelectric element PZ from deteriorating due to an influence of moisture or the like.

The sealing substrate 15 is provided with a through-hole 15h. The through-hole 15h is a hole that is located between the sealing space SP1 and the sealing space SP2 when the sealing substrate 15 is viewed in the Z1 direction, and penetrates from the surface of the sealing substrate 15 in the Z1 direction to the surface of the sealing substrate 15 in the Z2 direction. The wiring substrate 17 is inserted into the through-hole 15h.

As illustrated in FIGS. 4 and 5, the flow path forming substrate 16 is provided at a position in the Z2 direction when viewed from the communication plate 12. The flow path forming substrate 16 is a plate-shaped member elongated in the Y-axis direction and extending substantially parallel to the XY plane. The flow path forming substrate 16 is formed by, for example, injection molding of a resin material, and any known material and manufacturing method may be adopted to manufacture the flow path forming substrate 16.

As illustrated in FIG. 5, a flow path for inks is formed in the flow path forming substrate 16. Specifically, the flow path forming substrate 16 is formed with one supply flow path BB1 and one supply flow path BB2. Among these, the supply flow path BB1 is provided to communicate with the supply flow path BA1 and extend in the Y-axis direction at a position in the Z2 direction when viewed from the supply flow path BA1. The supply flow path BB2 is provided to communicate with the supply flow path BA2 and extend in the Y-axis direction at a position, which is a position in the Z2 direction when viewed from the supply flow path BA2 and in the X2 direction when viewed from the supply flow path BB1. The supply flow paths BB1 and BB2 are also referred to as a supply flow path BB without particular distinction.

The flow path forming substrate 16 is provided with the inlet HL1 communicating with

the supply flow path BB1 and the inlet HL2 communicating with the supply flow path BB2. The ink is supplied from the ink container CT to the supply flow path BB1 via the inlet HL1. The ink supplied from the ink container CT to the supply flow path BB1 via the inlet HL1 flows into the supply flow path BA1. The pressure chamber CVI is filled with a part of the ink flowing into the supply flow path BA1, via the coupling flow path BK1. When the piezoelectric element PZ1 is driven by the drive signal COM, the part of the ink filled in the pressure chamber CVI is ejected from the nozzle N1 via the communication flow path BR1.

In addition, the ink is supplied from the ink container CT to the supply flow path BB2 via the inlet HL2. The ink supplied from the ink container CT to the supply flow path BB2 via the inlet HL2 flows into the supply flow path BA2. The pressure chamber CV2 is filled with a part of the ink flowing into the supply flow path BA2, via the coupling flow path BK2. When the piezoelectric element PZ2 is driven by the drive signal COM, the part of the ink filled in the pressure chamber CV2 is ejected from the nozzle N2 via the communication flow path BR2.

The flow path forming substrate 16 is provided with a through-hole 16h. The through-hole 16h is a hole that is located between the supply flow path BB1 and the supply flow path BB2 when the flow path forming substrate 16 is viewed in the Z1 direction, and penetrates from a surface of the flow path forming substrate 16 in the Z1 direction to the surface of the flow path forming substrate 16 in the Z2 direction. The wiring substrate 17 is inserted into the through-hole 16h.

As illustrated in FIGS. 4 and 5, the wiring substrate 17 is mounted at the surface of the diaphragm 14 in the Z2 direction. The wiring substrate 17 is a component for electrically coupling the liquid ejecting head 1 to the control unit 4. As the wiring substrate 17, for example, a flexible wiring substrate such as a flexible printed circuit (FPC) or a flexible flat cable (FFC) is preferably adopted. As described above, the electronic component EC including the switching circuit 18, the detection circuit 19, and the like is mounted at the wiring substrate 17.

As illustrated in FIGS. 4 and 5, the compliance sheet CS1 is provided to close the supply flow path BA1 and the coupling flow path BK1, and the compliance sheet CS2 is provided to close the supply flow path BA2 and the coupling flow path BK2, at a position in the Z1 direction when viewed from the communication plate 12. The compliance sheets CS1 and CS2 are also referred to as a compliance sheet CS without particular distinction. The compliance sheet CS is a plate-shaped member elongated in the Y-axis direction and extending substantially parallel to the XY plane. The compliance sheet CS is formed with an elastic material, and absorbs the pressure fluctuation of the ink inside the supply flow path BA and the coupling flow path BK.

Here, as illustrated in FIG. 5, the ejecting portion D1 includes the piezoelectric element PZ1, the pressure chamber CV1, the nozzle N1 communicating with the pressure chamber CV1, and a portion of the diaphragm 14 that is in contact with the piezoelectric element PZ1. In the same manner, the ejecting portion D2 includes the piezoelectric element PZ2, the pressure chamber CV2, the nozzle N2 communicating with the pressure chamber CV2, and a portion of the diaphragm 14 that is in contact with the piezoelectric element PZ2. The ejecting portions D1 and D2 are also referred to as an ejecting portion D without particular distinction. Therefore, the residual vibration of the ejecting portion D is also considered as residual vibration corresponding to the nozzle N.

In addition, although not illustrated, the liquid ejecting head 1 has a cap for sealing a nozzle surface, which is a surface of the nozzle substrate 11 in the Z1 direction. The cap seals the nozzle surface of the nozzle substrate 11 at which the nozzle N is formed in a period in which the ink is not ejected from the nozzle N.

Next, an outline of the liquid ejecting head 1 will be described with reference to FIG. 6.

FIG. 6 is a block diagram illustrating an example of a configuration of the liquid ejecting head 1.

As described in FIG. 1, the liquid ejecting head 1 includes the recording head 10, the switching circuit 18, and the detection circuit 19. Further, the liquid ejecting head 1 has a wiring La to which the drive signal COMa is supplied from the drive signal generation unit 2 and a wiring Lb to which the drive signal COMb is supplied from the drive signal generation unit 2.

Further, the liquid ejecting head 1 includes a wiring Ls that supplies the detection signal Vout to the detection circuit 19, a wiring Li[m] that supplies the individual drive signal Vin[m] to the ejecting portion D[m], and a wiring Ld to which the bias potential VBS is supplied.

The switching circuit 18 includes M switches SWa[1] to SWa[M] corresponding to the M ejecting portions D[1] to D[M] on a one-to-one basis, M switches SWb[1] to SWb[M] corresponding to the M ejecting portions D[1] to D[M] on a one-to-one basis, and M switches SWs[1] to SWs[M] corresponding to the M ejecting portions D[1] to D[M] on a one-to-one basis.

Further, the switching circuit 18 includes a coupling state designation circuit CSC. The coupling state designation circuit CSC designates a coupling state of each of the M switches SWa, the M switches SWb, and the M switches SWs. For example, the coupling state designation circuit CSC may generate coupling state designation signals Qa[m], Qb[m], and Qs[m], based on at least some of the print signal SI, a latch signal LAT, and a period designation signal Tsig, which are supplied from the control unit 4.

For example, the coupling state designation signal Qa[m] is a signal for designating ON or OFF of the switch SWa[m], and the coupling state designation signal Qb[m] is a signal for designating ON or OFF of the switch SWb[m]. Further, the coupling state designation signal Qs[m] is a signal for designating ON or OFF of the switch SWs[m].

The switch SWa[m] switches conduction and non-conduction between the wiring La and the individual electrode Za[m] of the piezoelectric element PZ[m] provided in the ejecting portion D[m], based on the coupling state designation signal Qa[m]. That is, the switch SWa[m] switches conduction and non-conduction between the wiring La and the wiring Li[m] coupled to the individual electrode Za[m], based on the coupling state designation signal Qa[m]. In the present embodiment, the switch SWa[m] is turned on when the coupling state designation signal

Qa[m] is at a high level, and is turned off when the coupling state designation signal Qa[m] is at a low level. When the switch SWa[m] is turned on, the drive signal COMa supplied to the wiring La is supplied to the individual electrode Za[m] of the ejecting portion D[m] as the individual drive signal Vin[m] via the wiring Li[m].

The switch SWb[m] switches conduction and non-conduction between the wiring Lb and the individual electrode Za[m] of the piezoelectric element PZ[m] provided in the ejecting portion D[m], based on the coupling state designation signal Qb[m]. That is, the switch SWb[m] switches conduction and non-conduction between the wiring Lb and the wiring Li[m] coupled to the individual electrode Za[m], based on the coupling state designation signal Qb[m]. In the present embodiment, the switch SWb[m] is turned on when the coupling state designation signal Qb[m] is at a high level, and is turned off when the coupling state designation signal Qb[m] is at a low level. When the switch SWb[m] is turned on, the drive signal COMb supplied to the wiring Lb is supplied to the individual electrode Za[m] of the ejecting portion D[m] as the individual drive signal Vin[m] via the wiring Li[m].

The switch SWs[m] switches conduction and non-conduction between the wiring Ls and the individual electrode Za[m] of the piezoelectric element PZ[m] provided in the ejecting portion D[m], based on the coupling state designation signal Qs[m]. That is, the switch SWs[m] switches conduction and non-conduction between the wiring Ls and the wiring Li[m] coupled to the individual electrode Za[m], based on the coupling state designation signal Qs[m]. In the present embodiment, the switch SWs[m] is turned on when the coupling state designation signal Qs[m] is at a high level, and is turned off when the coupling state designation signal Qs[m] is at a low level.

For example, the coupling state designation signal Qs[m] becomes a high level when the residual vibration of the ejecting portion D[m] is detected. In the following, the ejecting portion D in which the residual vibration is detected may be referred to as the ejecting portion D as a detection target. When the switch SWs[m] is turned on, the detection signal Vout[m] indicating a potential of the individual electrode Za[m] of the piezoelectric element PZ[m] included in the ejecting portion D[m] as a detection target is supplied to the detection circuit 19 via the wiring Li[m] and the wiring Ls. The detection circuit 19 generates the residual vibration signal Vd[m] based on the detection signal Vout[m].

As described above, the individual drive signal Vin[m] is a signal supplied to the piezoelectric element PZ[m] of the ejecting portion D[m] via the switch SWa[m] or SWb[m], among the drive signals COMa and COMb.

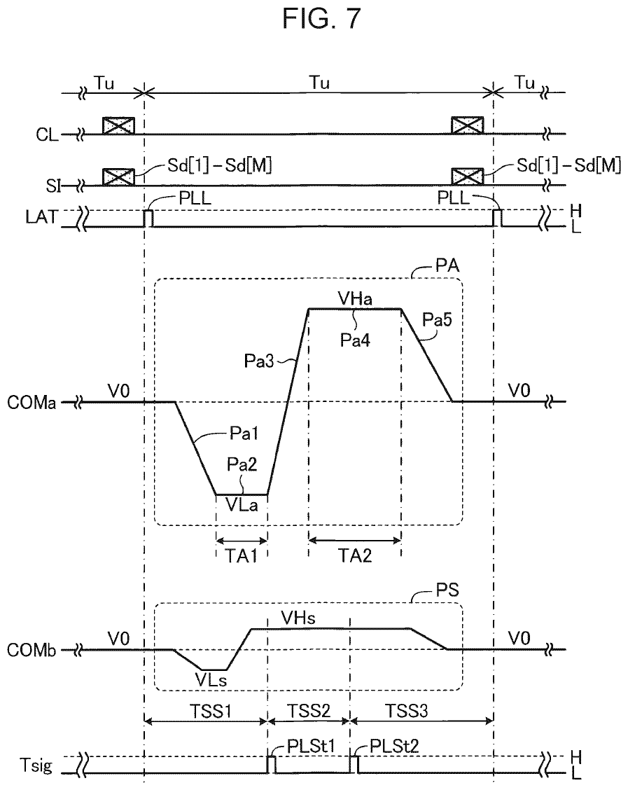

Next, an operation of the liquid ejecting apparatus 100 in a unit period Tu will be described with reference to FIG. 7.

FIG. 7 is a timing chart illustrating an example of the operation of the liquid ejecting apparatus 100 in the unit period Tu. In the present embodiment, when the liquid ejecting apparatus 100 executes a printing process, a printing process period including one or a plurality of unit periods Tu is set as an operation period of the liquid ejecting apparatus 100. The liquid ejecting apparatus 100 according to the present embodiment can drive each ejecting portion D for the printing process in each unit period Tu. Further, the liquid ejecting apparatus 100 according to the present embodiment can drive the ejecting portion D as a detection target and detect the detection signal Vout[m] from the ejecting portion D as a detection target in each unit period Tu.

The control unit 4 outputs the latch signal LAT having a pulse PLL. Therefore, the control unit 4 defines the unit period Tu as a period from rising of the pulse PLL to rising of the next pulse PLL.

The print signal SI includes, for example, M individual designation signals Sd[1] to Sd[M] corresponding to the M ejecting portions D[1] to D[M] on a one-to-one basis. The individual designation signal Sd[m] designates a mode of the driving of the ejecting portion D[m] in each unit period Tu when the liquid ejecting apparatus 100 executes the printing process.

The control unit 4 supplies the print signal SI including the individual designation signals Sd[1] to Sd[M] to the coupling state designation circuit CSC in synchronization with a clock signal CL before each unit period Tu in which the printing process is executed. The coupling state designation circuit CSC generates the coupling state designation signals Qa[m], Qb[m], and Qs[m] based on the individual designation signal Sd[m] in the unit period Tu.

For example, the ejecting portion D[m] is designated as any of the ejecting portion D that forms a dot, the ejecting portion D that does not form a dot, and the ejecting portion D as a detection target, by the individual designation signal Sd[m], in a unit period TP during which the printing process is executed.

First, an operation of the coupling state designation circuit CSC or the like when a driving mode as the ejecting portion D for forming a dot is designated by the individual designation signal Sd[m] will be described.

The drive signal generation unit 2 outputs the drive signal COMa having a pulse PA. The pulse PA is, for example, a pulse for ejecting the ink from the nozzle N. The pulse PA is a waveform in which a potential of the drive signal COMa is changed from a potential V0 and returns to the potential V0, via a potential VLa less than the potential V0 and a potential VHa more than the potential V0. The potential V0 is a potential at a start and an end of the pulse PA, and is a reference potential of the drive signal COMa.

For example, the pulse PA has a waveform element Pa1 in which a potential is changed from the potential V0 to the potential VLa, a waveform element Pa2 in which the potential is maintained at the potential VLa at an end of the waveform element Pa1, and a waveform element Pa3 in which the potential is changed from the potential VLa to the potential VHa. Further, the pulse PA includes a waveform element Pa4 in which the potential is maintained at the potential VHa at an end of the waveform element Pa3, and a waveform element Pa5 in which the potential is changed from the potential VHa to the potential V0.

The waveform elements Pa1 and Pa5 are expansion elements for displacing the piezoelectric body Zb in the Z2 direction. In the expansion element, the potential of the drive signal COMa is changed for driving the piezoelectric element PZ to expand a volume of the pressure chamber CV. Therefore, in the waveform elements Pa1 and Pa5, the potential of the drive signal COMa is changed to expand the volume of the pressure chamber CV. When the volume of the pressure chamber CV expands, a surface of the ink in the nozzle Nis pulled in the Z2 direction, which is a direction opposite to an ejection direction. In the following, the pulling of the surface of the ink in the nozzle N in the direction opposite to the ejection direction may be referred to as a pull.

In addition, the waveform element Pa3 is a contraction element for displacing the piezoelectric body Zb in the Z1 direction. In the contraction element, the potential of the drive signal COMa is changed for driving the piezoelectric element PZ to contract the volume of the pressure chamber CV. Therefore, in the waveform element Pa3, the potential of the drive signal COMa is changed to contract the volume of the pressure chamber CV. When the volume of the pressure chamber CV is reduced, the surface of the ink in the nozzle N is pushed out in the Z1 direction, which is the ejection direction. In the following, the act of pushing the surface of the ink in the nozzle N in the ejection direction may be referred to as a push.

In addition, the waveform elements Pa2 and Pa4 are maintenance elements for maintaining a position of the piezoelectric body Zb in the Z-axis direction. For example, in the waveform element Pa2, the potential of the drive signal COMa is maintained for driving the piezoelectric element PZ to maintain the volume of the pressure chamber CV expanded by the waveform element Pal. In addition, for example, in the waveform element Pa4, the potential of the drive signal COMa is maintained for driving the piezoelectric element PZ to maintain the volume of the pressure chamber CV contracted by the waveform element Pa3.

In this manner, the pulse PA is a so-called pull-push-pull waveform. Meanwhile, a waveform of the drive signal COMa for ejecting the ink from the nozzle N is not limited to the pull-push-pull waveform.

The pulse PA is determined such that a predetermined amount of ink is ejected from the ejecting portion D[m] when the individual drive signal Vin[m] having the pulse PA is supplied to the ejecting portion D[m]. In the present embodiment, a case is assumed in which the volume of the pressure chamber CV provided in the ejecting portion D[m] is reduced when a potential of the individual drive signal Vin[m] is a high potential as compared with a case where the potential is a low potential. Therefore, when the ejecting portion D[m] is driven by the individual drive signal Vin[m] having the pulse PA, the ink in the ejecting portion D[m] is ejected from the nozzle N by the waveform element Pa3 in which the potential of the individual drive signal Vin[m] is changed from the low potential to the high potential.

For example, the waveform elements Pa1, Pa2, Pa3, Pa4, and Pa5 included in the pulse PA are determined based on an ejection characteristic of the ink by the ejecting portion D and the like. The ejection characteristic of the ink is, for example, the amount of ink ejected as ink droplets, an ejection speed of the ejected ink droplets, or the like.

Here, a variation in parameter related to a behavior of the ink such as a natural vibration cycle of the pressure chamber CV causes a variation in ejection characteristic of the ink. The natural vibration cycle of the pressure chamber CV is specified based on, for example, the residual vibration of the diaphragm 14 detected by the detection circuit 19. Therefore, in the present embodiment, for example, the waveform of the drive signal COMa, that is, a waveform of the pulse PA is determined based on the residual vibration information Vinf indicating a waveform of the residual vibration of the diaphragm 14. In the present embodiment, a case is described in which a length TA1 of the waveform element Pa2 and a length TA2 of the waveform element Pa4 are adjusted based on the residual vibration information Vinf with respect to a reference waveform which is a predetermined waveform of the pulse PA. In the present embodiment, a case is assumed in which a start timing of the waveform element Pa2 and a start timing of the waveform element Pa4 when a start timing of the waveform element Pal is used as a starting point are not changed before and after adjustment of the lengths TA1 and TA2.

Therefore, for example, when the length TA1 is long, the potential change amount per unit time of the waveform element Pa3, that is, an inclination of the waveform element Pa3 is more than the inclination when the length TA1 is short. For example, when the inclination of the waveform element Pa3 is large, an ejection speed of the ink droplet is more than the ejection speed when the inclination of the waveform element Pa3 is small. In addition, for example, when the length TA2 is long, the potential change amount per unit time of the waveform element

Pa5, that is, an inclination of the waveform element Pa5 is more than the inclination when the length TA2 is short. When the inclination of the waveform element Pa5 is large, a vibration damping capacity for attenuating the residual vibration of the ejecting portion D is more than the vibration damping capacity when the inclination of the waveform element Pa5 is small. The method of adjusting the waveform of the pulse PA, that is, the method of determining the waveform of the pulse PA is not limited to adjusting the length TA1 of the waveform element Pa2 and the length TA2 of the waveform element Pa4. For example, one or both of the potentials VHa and VLa may be adjusted based on the residual vibration information Vinf with respect to the reference waveform of the pulse PA. For example, with respect to the reference waveform of the pulse PA, the inclination of the waveform element Pa3 and the inclination of the waveform element Pa5 may be adjusted based on the residual vibration information Vinf without changing the length TA1 of the waveform element Pa2 and the length TA2 of the waveform element Pa4. In addition, for example, with respect to the reference waveform of the pulse PA, some or all of the potential VHa, the potential VLa, the length TA1, the length TA2, the inclination of the waveform element Pa3, and the inclination of the waveform element Pa5 may be adjusted based on the residual vibration information Vinf.

The residual vibration indicated by the residual vibration information Vinf used to determine the waveform of the pulse PA is residual vibration representing residual vibration of the M ejecting portions D. For example, the residual vibration representing the residual vibration of the M ejecting portions D may be residual vibration of one ejecting portion D among the M ejecting portions D. Alternatively, the residual vibration representing the residual vibration of the M ejecting portions D may be statistically specified by using residual vibration of the K ejecting portions D. For example, the residual vibration representing the residual vibration of the M ejecting portions D may be an average value of the residual vibrations of the K ejecting portions D, or may be a maximum value or a minimum value of the residual vibrations of the K ejecting portions D. The value K is a natural number satisfying “2≤K≤M”.

Next, an operation of the coupling state designation circuit CSC or the like when a driving mode of the ejecting portion D as a detection target is designated by the individual designation signal Sd[m] will be described.

For example, the drive signal generation unit 2 outputs the drive signal COMb having a pulse PS. The pulse PS is a waveform in which a potential of the drive signal COMb is changed from the potential V0 and returns to the potential V0, via a potential VLs less than the potential V0 and a potential VHs more than the potential V0. In the present embodiment, the pulse PS is determined such that a potential difference between the potential VHS, which is the highest potential of the pulse PS, and the potential VLS, which is the lowest potential of the pulse PS, is less than a potential difference between the potential VHa, which is the highest potential of the pulse PA, and the potential VLa, which is the lowest potential of the pulse PA. Specifically, when the drive signal COMb having the pulse PS is supplied to the ejecting portion D[m], a waveform of the pulse PS is defined to drive the ejecting portion D[m] to such an extent that an ink is not ejected from the ejecting portion D[m]. The potentials at a start and an end of the pulse PS are set to the potential V0.

The control unit 4 outputs the period designation signal Tsig having a pulse PLSt1 and a pulse PLSt2. Therefore, the control unit 4 divides the unit period Tu into a control period TSS1 from a start of the pulse PLL to a start of the pulse PLSt1, a control period TSS2 from a start of the pulse PLSt1 to a start of the pulse PLSt2, and a control period TSS3 from a start of the pulse PLSt2 to a start of the next pulse PLL.

For example, when the individual designation signal Sd[m] designates the ejecting portion D[m] as the ejecting portion D of a detection target, the coupling state designation circuit CSC sets the coupling state designation signal Qa[m] to a low level in the unit period Tu. Further, the coupling state designation circuit CSC sets the coupling state designation signal Qb[m] to a high level in the control periods TSS1 and TSS3 and to a low level in the control period TSS2, respectively. Further, the coupling state designation circuit CSC sets the coupling state designation signal Qs[m] to a low level in the control periods TSS1 and TSS3 and to a high level in the control period TSS2, respectively.

In this case, the piezoelectric element PZ[m] included in the ejecting portion D[m] as a detection target is driven by the pulse PS of the drive signal COMb in the control period TSS1. Specifically, the piezoelectric element PZ[m] is displaced by the pulse PS of the drive signal COMb in the control period TSS1. As a result, vibration is generated in the ejecting portion D[m] as a detection target. The vibration generated in the control period TSS1 remains in the control period TSS2. In the control period TSS2, the potential of the individual electrode Za[m] of the piezoelectric element PZ[m] included in the ejecting portion D[m] as a detection target is changed according to the residual vibration generated in the ejecting portion D[m]. That is, in the control period TSS2, the potential of the individual electrode Za of the piezoelectric element PZ included in the ejecting portion D as a detection target is a potential according to an electromotive force of the piezoelectric element PZ caused by the residual vibration generated in the ejecting portion D as a detection target. The potential of the individual electrode Za is detected as the detection signal Vout in the control period TSS2.

In addition, when a driving mode as the ejecting portion D that does not form dots is designated by the individual designation signal Sd[m], for example, the coupling state designation circuit CSC sets the coupling state designation signals Qa[m], Qb[m], and Qs[m] to a low level in the unit period Tu.

The operation of the liquid ejecting apparatus 100 is not limited to the example illustrated in FIG. 7. For example, in FIG. 7, a case is illustrated as an example in which there is one drive signal COM for ejecting an ink from the nozzle N, and the present disclosure is not limited to such an aspect. For example, the plurality of drive signals COM corresponding to sizes of dots may be used as the drive signal COM for ejecting the ink from the nozzle N. In addition, the plurality of drive signals COM may include the drive signal COM having a minute vibration waveform for preventing thickening of the ink.

In addition, in FIG. 7, a case is illustrated as an example in which the detection signal Vout indicating the residual vibration of the ejecting portion D as a detection target is generated during the printing process period, and the detection signal Vout may be generated during a period different from the printing process period. That is, the process of detecting the residual vibration of the ejecting portion D as a detection target may be executed in a period different from the printing process period.

Next, the adjustment information Ainf for adjusting a waveform of the drive signal COMa will be described with reference to FIG. 8.

FIG. 8 is a diagram describing the adjustment information Ainf for adjusting the waveform of the drive signal COMa. In FIG. 8, as a note, the waveform of the drive signal COMa is illustrated. In the present embodiment, a case is assumed in which one piece of adjustment information Ainf is adopted for each liquid ejecting head 1. In FIG. 8, a plurality of pieces of adjustment information Ainf are illustrated for easy understanding of the description.

In the present embodiment, as described with reference to FIG. 7, the length TA1 of the waveform element Pa2 and the length TA2 of the waveform element Pa4 are adjusted based on the residual vibration indicated by the residual vibration information Vinf with respect to the reference waveform of the pulse PA. In the following, the length TA1 of the waveform element Pa2 in the reference waveform of the pulse PA is also referred to as the length TA1 of the waveform element Pa2 of the reference waveform, and the length TA2 of the waveform element Pa4 in the reference waveform of the pulse PA is also referred to as the length TA2 of the waveform element Pa4 of the reference waveform. For example, in the present embodiment, as illustrated in FIG. 8, the adjustment information Ainf indicates an adjustment value for the length TA1 of the waveform element Pa2 of the reference waveform and an adjustment value for the length TA2 of the waveform element Pa4 of the reference waveform.

In the example illustrated in FIG. 8, the length TA1 of the waveform element Pa2 is determined as a value obtained by multiplying the length TA1 of the waveform element Pa2 of the reference waveform by an adjustment value of the length TA1, and the length TA2 of the waveform element Pa4 is determined as a value obtained by multiplying the length TA2 of the waveform element Pa4 of the reference waveform by an adjustment value of the length TA2. The adjustment of the length TA1 and the length TA2 is not necessarily adjusted by multiplication, and may be adjusted by another method such as addition and subtraction.

For example, in the adjustment information Ainf1, the adjustment value of the length TA1 is 0.9, and the adjustment value of the length TA2 is 0.8. In the adjustment information Ainf2, both the adjustment value of the length TA1 and the adjustment value of the length TA2 are 1.0. In the adjustment information Ainf3, the adjustment value of the length TA1 is 1.2, and the adjustment value of the length TA2 is 1.1. In the example illustrated in FIG. 8, the drive signal COMa having the waveform of the pulse PA as the reference waveform is supplied to the liquid ejecting head 1 to which the adjustment information Ainf2 is adopted.

The content of the adjustment information Ainf is not limited to the example illustrated in FIG. 8. For example, the adjustment value of the length TA1 and the adjustment value of the length TA2 may be numerical values other than the numerical value illustrated in FIG. 8. The method of the adjustment can also be appropriately changed. In addition, the waveform of the drive signal COMa may be determined without using the reference waveform of the pulse PA. For example, the adjustment information Ainf may be the waveform designation signal dCOM that defines the waveform of the pulse PA.

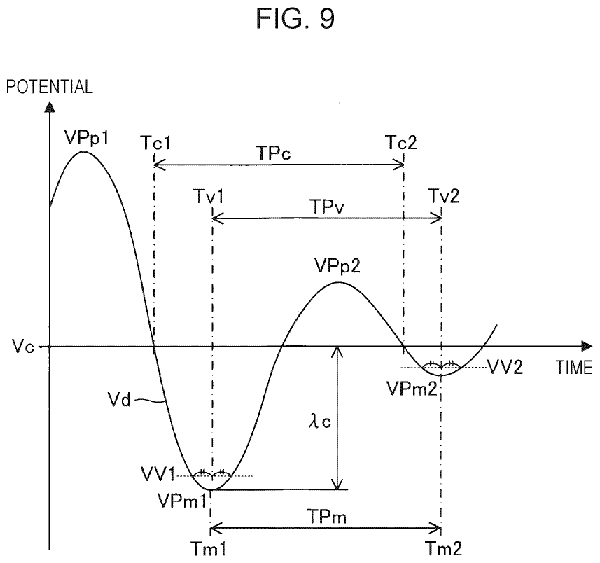

Next, an outline of the residual vibration signal Vd will be described with reference to FIG. 9.

FIG. 9 is a diagram illustrating an example of a waveform of the residual vibration signal Vd. FIG. 9 schematically illustrates the example of the waveform of the residual vibration signal Vd, that is, a waveform of the residual vibration indicated by the residual vibration information Vinf. A vertical axis of a graph indicates a potential of the residual vibration signal Vd, and a horizontal axis indicates a time.

As described above, the residual vibration signal Vd indicates a waveform corresponding to residual vibration of the ejecting portion D as a detection target, that is, residual vibration of the diaphragm 14. Specifically, the residual vibration signal Vd indicates a cycle corresponding to a cycle of the residual vibration of the diaphragm 14, an amplitude corresponding to an amplitude of the residual vibration of the diaphragm 14, and a phase corresponding to a phase of the residual vibration of the diaphragm 14.

In the example illustrated in FIG. 9, peaks VPp1 and VPp2 indicate a peak VPp at which the potential of the residual vibration signal Vd becomes the maximum value, that is, the peak VPp at which the waveform of the residual vibration signal Vd becomes a mountain. Peaks VPm1 and VPm2 indicate a peaks VPm at which the potential of the residual vibration signal Vd becomes the minimum value, that is, the peaks VPm at which the waveform of the residual vibration signal Vd becomes a valley. A potential Vc indicates a reference potential of the residual vibration signal Vd. For example, the potential Vc may be a potential of the residual vibration signal Vd when the residual vibration of the diaphragm 14 is attenuated and the residual vibration is settled, or may be an intermediate potential between a potential of the peak VPp and a potential of the peak VPm.

A timing Tc1 indicates a timing at which the potential of the residual vibration signal Vd becomes the potential Vc when the potential of the residual vibration signal Vd is changed from the potential of the peak VPp1 to a potential of the peak Vpm1. A timing Tc2 indicates a timing at which the potential of the residual vibration signal Vd becomes the potential Vc when the potential of the residual vibration signal Vd is changed from the potential of the peak VPp2 to a potential of the peak Vpm2. A time length TPc indicates a time from the timing Tc1 to the timing Tc2. That is, the time length TPc is specified based on a timing at which the potential of the residual vibration signal Vd becomes the potential Vc. A time length TPm indicates a time from a timing Tm1 of the peak VPm1 to a timing Tm2 of the peak VPm2. That is, the time length TPm is specified based on a timing of the peak VPm.

For example, in analysis of the residual vibration in step S220 illustrated in FIG. 11 to be described below, a cycle of the residual vibration signal Vd is specified as a cycle of the residual vibration of the diaphragm 14. The cycle of the residual vibration signal Vd may be, for example, the time length TPc or the time length TPm. Alternatively, the cycle of the residual vibration signal Vd may be a time length TPv which is a time from a timing Tvl to a timing Tv2. The timing Tv1 is an intermediate timing of a timing at which the potential of the residual vibration signal Vd becomes any potential VV1 between the potential Vc and the potential of the peak VPm1 before and after the timing Tm1. The timing Tv2 is an intermediate timing of a timing at which the potential of the residual vibration signal Vd becomes any potential VV2 between the potential Vc and the potential of the peak VPm2 before and after the timing Tm2. The potential Vc may be the potentials VV1 and VV2. In the mode in which the time length TPv is set to the cycle of the residual vibration signal Vd, it is expected that an influence of distortion is reduced even when the waveform of the residual vibration signal Vd is distorted.

The specific method for the cycle of the residual vibration signal Vd is not limited to the example described above, and a known method can be adopted. For example, the cycle of the residual vibration signal Vd may be an average of a plurality of time lengths specified based on a timing at which the potential of the residual vibration signal Vd becomes the potential Vc, or may be an average of a plurality of time lengths specified based on the timing of the peak VPm. Alternatively, the cycle of the residual vibration signal Vd may be a time length specified based on a timing of the peak VPp, or may be an average of a plurality of time lengths specified based on the timing of the peak VPp.

In addition, for example, in the analysis of the residual vibration, an amplitude of the residual vibration signal Vd is specified as the amplitude of the residual vibration of the diaphragm 14. The amplitude of the residual vibration signal Vd may be, for example, an amplitude of the peak VPp or an amplitude of the peak VPm. An amplitude Ac of the peak VPm1 is an absolute value of the difference between the potential of the peak VPm1 and the potential Vc.

The specific method of the amplitude of the residual vibration signal Vd is not limited to the example described above, and a known method can be adopted. For example, the amplitude of the residual vibration signal Vd may be an amplitude of the first or second peak VPp, or may be an average of amplitudes of a plurality of peaks VPp. Alternatively, the amplitude of the residual vibration signal Vd may be an amplitude of the second peak VPm or an average of amplitudes of a plurality of peaks VPm. In addition, the amplitude of the residual vibration signal Vd may be an average of an amplitude of one or more peaks VPp and an amplitude of one or more peaks VPm. In addition, an attenuation rate of the amplitude of the residual vibration signal Vd may be specified as an attenuation rate of the amplitude of the residual vibration of the diaphragm 14.

In addition, for example, in the analysis of the residual vibration, a phase of the residual vibration signal Vd is specified as a phase of the residual vibration of the diaphragm 14. The specific method of the phase of the residual vibration signal Vd is not particularly limited, and a known method can be adopted.

The waveform of the drive signal COMa is adjusted based on at least one of the cycle, the amplitude, the attenuation rate of the amplitude, and the phase of the residual vibration, for example. For example, the waveform of the drive signal COMa may be adjusted based on the cycle of the residual vibration, or may be adjusted based on the cycle and the amplitude of the residual vibration. An analysis result of the residual vibration used for adjusting the waveform of the drive signal COMa is not limited to the cycle, the amplitude, the attenuation rate of the amplitude, and the phase of the residual vibration.

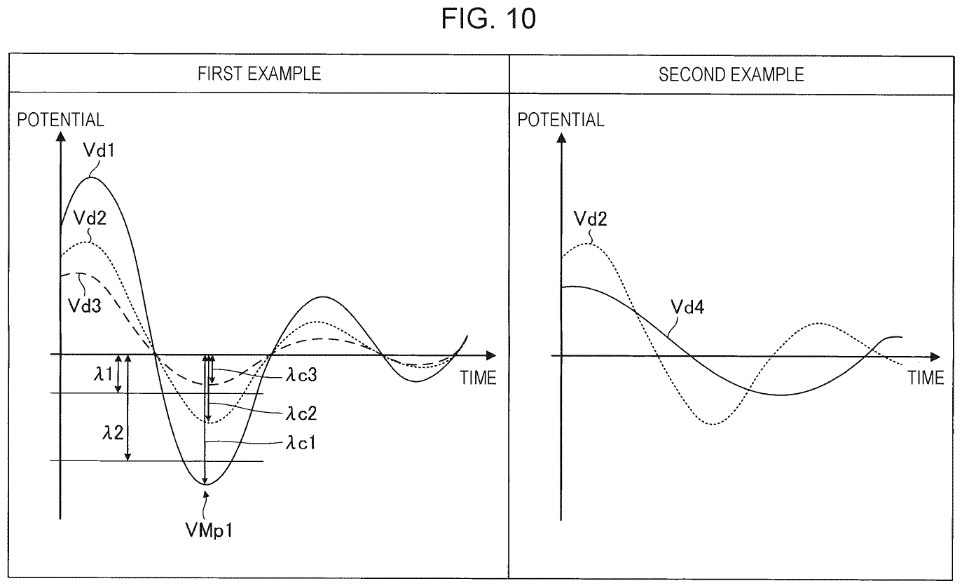

Next, with reference to FIG. 10, a difference in waveform of the residual vibration signal Vd depending on a use condition of the liquid ejecting head 1 will be described.

FIG. 10 is a diagram describing the difference in waveform of the residual vibration signal Vd depending on the use condition of the liquid ejecting head 1. In a first example in FIG. 10, an example of a waveform of the residual vibration signal Vd assumed by a head manufacturer is schematically illustrated, and in a second example in FIG. 10, an example of a waveform of the residual vibration signal Vd not assumed by the head manufacturer is schematically illustrated. A vertical axis of a graph indicates a potential of the residual vibration signal Vd, and a horizontal axis indicates a time.

For example, when an ink recommended by the head manufacturer is used, residual vibration having a certain degree of correlation in a cycle, an amplitude, and the like is detected as in the first example, even though ink conditions such as a type of ink are different. In the first example, a case is assumed in which a first ink, a second ink, and a third ink recommended by the head manufacturer are used. For example, a residual vibration signal Vd1 is a residual vibration signal Vd indicating residual vibration detected in a state in which the pressure chamber

CV is filled with the first ink. A residual vibration signal Vd2 is a residual vibration signal Vd indicating residual vibration detected in a state in which the pressure chamber CV is filled with the second ink. A residual vibration signal Vd3 is a residual vibration signal Vd indicating residual vibration detected in a state in which the pressure chamber CV is filled with the third ink.

In the first example in FIG. 10, the cycles of the residual vibration signals Vd are the same as each other in the three types of ink, and the amplitudes λc of the residual vibration signals Vd are different in the three types of ink. For example, among an amplitude λcl of the residual vibration signal Vd1, an amplitude λc2 of the residual vibration signal Vd2, and an amplitude λc3 of the residual vibration signal Vd3, the amplitude λcl of the residual vibration signal Vd1 is the highest and the amplitude λc3 of the residual vibration signal Vd3 is the lowest.

Since a behavior of the residual vibration remaining in the ink in the pressure chamber CV of the ejecting portion D differs depending on the three types of ink, it is considered that an appropriate waveform of the drive signal COMa for driving the ejecting portion D also differs depending on the three types of ink. Since waveforms of a plurality of residual vibration signals Vd illustrated in the first example are waveforms assumed by the head manufacturer as described above, the head manufacturer can also prepare a plurality of pieces of adjustment information Ainf corresponding to the plurality of residual vibration signals Vd illustrated in the first example in advance.

On the other hand, for example, when a special ink that is not assumed by the head manufacturer is used, there is a concern that the behavior of the ink in the pressure chamber CV is significantly different from the behavior of the ink when the ink recommended by the head manufacturer is used. In this case, as illustrated in the second example, it is considered that a waveform of the residual vibration signal Vd4 is also significantly different from the waveform assumed by the head manufacturer. For example, the residual vibration signal Vd4 illustrated in the second example is the residual vibration signal Vd indicating residual vibration detected when a special ink not assumed by the head manufacturer is used.

It is difficult for the head manufacturer to prepare in advance the adjustment information Ainf corresponding to the residual vibration signal Vd, which is significantly different from the waveform assumed by the head manufacturer. Therefore, in the liquid ejecting apparatus in which the adjustment information Ainf is prepared in advance by the head manufacturer, when the waveform of the residual vibration signal Vd is significantly different from the waveform assumed in the head manufacturer, it is difficult to appropriately adjust the waveform of the drive signal COMa.

Therefore, in the present embodiment, the residual vibration information Vinf indicating the residual vibration detected by the detection circuit 19 is transmitted to the server 200, and the adjustment information Ainf is generated by the head manufacturer based on the residual vibration information Vinf. Therefore, in the present embodiment, even when the waveform of the residual vibration detected by the detection circuit 19 is significantly different from the waveform assumed by the head manufacturer, the adjustment information Ainf for appropriately adjusting the waveform of the drive signal COMa is generated by the head manufacturer.

The fact that the adjustment information Ainf is generated by the head manufacturer means that the residual vibration information Vinf is generated by the server 200, and also means that the residual vibration information Vinf is generated by a user of the server 200. The adjustment information Ainf generated by the head manufacturer is transmitted from the server 200 to the liquid ejecting apparatus 100 as described in FIG. 1 and the like. As a result, in the present embodiment, even when the waveform of the residual vibration signal Vd is significantly different from the waveform assumed by the head manufacturer, the waveform of the drive signal COMa can be appropriately adjusted. In the present embodiment, the residual vibration information Vinf is transmitted from the liquid ejecting apparatus 100 to the server 200, regardless of whether or not the waveform of the residual vibration signal Vd is the waveform assumed by the head manufacturer.

Next, an operation of the liquid ejecting system SYS when adjusting a waveform of the drive signal COMa will be described with reference to FIG. 11.

FIG. 11 is a diagram illustrating an example of the operation of the liquid ejecting system SYS when adjusting the waveform of the drive signal COMa. The operation illustrated in FIG. 11 is executed at each of the plurality of liquid ejecting heads 1, for example. A timing at which the operation illustrated in FIG. 11 is executed is not particularly limited, and it is preferable to be executed when the liquid ejecting apparatus 100 is used for a first time or when a use condition of the liquid ejecting apparatus 100 is changed due to a change in type of ink to be used. The use condition of the liquid ejecting apparatus 100 also includes a use condition of the liquid ejecting head 1.

The use condition of the liquid ejecting head 1 includes, for example, a part or all of the ink condition related to a type of ink, a temperature condition related to a temperature, and a pressure condition related to the pressure. The use condition of the liquid ejecting head 1 may be a condition other than the ink condition, the temperature condition, and the pressure condition. The temperature of the temperature condition may be a temperature of the ink, or may be a temperature of the liquid ejecting head 1. In addition, the pressure of the pressure condition may be a pressure near the pressure chamber CV, or may be a pressure of a flow path of the ink. In the present embodiment, a case is assumed in which the temperature and the pressure are respectively detected by a temperature sensor and a pressure sensor, which are provided in the vicinity of the pressure chamber CV. Meanwhile, the temperature and the pressure may be detected by a method other than the method using the temperature sensor and the pressure sensor, which are provided in the vicinity of the pressure chamber CV. For example, the temperature and the pressure may be respectively detected by a thermistor inside the liquid ejecting apparatus 100 and a pressure sensor provided at an outside flow path of the liquid ejecting head 1.

Further, in the operation illustrated in FIG. 11, a case is assumed in which condition information Cinf, the residual vibration information Vinf, and the adjustment information Ainf related to the use condition of the liquid ejecting head 1 are associated with each other and stored in the database DB. The condition information Cinf includes, for example, a part or all of information on the type of ink, information on the temperature, and information on the pressure. That is, the condition information Cinf includes a part or all of information indicating the ink condition, information indicating the temperature condition, and information indicating the pressure condition. In addition, in the description in FIG. 11, the user means a user of the liquid ejecting apparatus 100, among a user of the liquid ejecting apparatus 100 and a user of the server 200. That is, in the following, the user of the liquid ejecting apparatus 100 is simply referred to as a user.

The control unit 4 of the liquid ejecting apparatus 100 functions as the processing control portion 40 in steps S100, S110, S112, S120, S140, S142, and S150 illustrated in FIG. 11. In addition, the control unit 4 functions as the transmission control portion 42 in steps S114 and S122 illustrated in FIG. 11, and functions as the reception control portion 44 in step S130.

Further, the control unit 204 of the server 200 functions as the adjustment control portion 210 in each step from step S200 to step S240 illustrated in FIG. 11.

First, in step $100, the liquid ejecting apparatus 100 determines whether or not to cause a head manufacturer to perform waveform adjustment including a determination or the like of an adjustment value for adjusting a waveform of the drive signal COMa. For example, the processing control portion 40 displays, on the display device 120, an operation button for selecting whether or not to cause the head manufacturer to perform the waveform adjustment as a graphical user interface (GUI). Then, when the operation button is selected for causing the head manufacturer to perform the waveform adjustment, the processing control portion 40 determines that the waveform adjustment is to be performed by the head manufacturer. Further, when the operation button is selected not to perform the waveform adjustment by the head manufacturer, the processing control portion 40 determines that the waveform adjustment is not to be performed by the head manufacturer. The fact that the head manufacturer performs the waveform adjustment may be, for example, that the server 200 executes the waveform adjustment, or that the user of the server 200 performs the waveform adjustment.

When a result of the determination in step S100 is affirmative, the processing control portion 40 shifts the process to step S110. On the other hand, when the result of the determination in step S100 is negative, the processing control portion 40 shifts the process to step S150.

In step S110, the liquid ejecting apparatus 100 accepts a selection as to whether or not to transmit the condition information Cinf related to a use condition of the liquid ejecting head 1. For example, the processing control portion 40 displays, on the display device 120, an operation button for selecting whether or not to transmit the condition information Cinf to the server 200 as the GUI. In this manner, the processing control portion 40 accepts the selection from the user as to whether or not to transmit the condition information Cinf to the server 200.

Therefore, the condition information Cinf can be prevented from being transmitted to the server 200 against the intention of the user.

Next, in step S112, the processing control portion 40 determines whether or not to transmit the condition information Cinf to the server 200, based on a reception result in the process in step S110. For example, when transmission of the condition information Cinf to the server 200 is selected in step S110, the processing control portion 40 determines that the condition information Cinf is to be transmitted to the server 200. Further, when non-transmission of the condition information Cinf to the server 200 is selected in step S110, the processing control portion 40 determines that the condition information Cinf is not to be transmitted to the server 200.

When a result of the determination in step S112 is affirmative, the processing control portion 40 shifts the process to step S114. On the other hand, when the result of the determination in step S112 is negative, the processing control portion 40 shifts the process to step S120.

In step S114, the liquid ejecting apparatus 100 transmits the condition information Cinf to the server 200. For example, the transmission control portion 42 transmits the condition information Cinf to the server 200 via the communication unit 6.

By executing the process in step S114, in step S200, the server 200 receives the condition information Cinf. For example, in step S200, the adjustment control portion 210 receives the condition information Cinf from the liquid ejecting apparatus 100 via the communication unit 206.

Further, the transmission control portion 42 shifts the process to step S120 after executing the process in step S114.

In step S120, the liquid ejecting apparatus 100 detects residual vibration of the diaphragm 14. For example, the processing control portion 40 causes the detection circuit 19 to detect the residual vibration. Specifically, the processing control portion 40 drives the ejecting portion D[m] which is a residual vibration detection target as the ejecting portion D of a detection target in a driving mode described with reference to FIG. 7. Therefore, the detection circuit 19 detects the residual vibration of the diaphragm 14 after the piezoelectric element PZ[m] is driven, based on the detection signal Vout[m].

Next, in step S122, the liquid ejecting apparatus 100 transmits the residual vibration information Vinf indicating a waveform of the residual vibration detected by the detection circuit 19 to the server 200. For example, the transmission control portion 42 transmits the residual vibration information Vinf to the server 200 via the communication unit 6.

By executing the process in step S122, in step S202, the server 200 receives the residual vibration information Vinf. For example, in step S202, the adjustment control portion 210 receives the residual vibration information Vinf from the liquid ejecting apparatus 100 via the communication unit 206. The adjustment control portion 210 shifts the process to step S210 after receiving the residual vibration information Vinf.

In step S210, the adjustment control portion 210 determines whether or not the condition information Cinf is received from the liquid ejecting apparatus 100. When a result of the determination in step S210 is negative, the adjustment control portion 210 shifts the process to step S220. On the other hand, when the result of the determination in step S210 is affirmative, the adjustment control portion 210 shifts the process to step S212.

In step S212, the adjustment control portion 210 determines whether or not a use condition similar to the use condition indicated by the condition information Cinf received in step S200 is registered in the database DB. For example, the adjustment control portion 210 determines whether or not the condition information Cinf indicating the use condition similar to the use condition indicated by the condition information Cinf received in step S200 is stored in the database DB. The use condition similar to the use condition indicated by the condition information Cinf includes a use condition that coincides with the use condition indicated by the condition information Cinf. In the following, the condition information Cinf indicating a use condition similar to a use condition indicated by one condition information Cinf is also referred to as the condition information Cinf similar to one condition information Cinf.

When a result of the determination in step S212 is negative, the adjustment control portion 210 shifts the process to step S220. On the other hand, when the result of the determination in step S212 is affirmative, the adjustment control portion 210 shifts the process to step S214. That is, when the condition information Cinf indicating a use condition similar to the use condition indicated by the condition information Cinf received in step S200 is searched from the database DB, the process in step S214 is executed.

In step S214, the adjustment control portion 210 determines whether or not residual vibration similar to residual vibration indicated by the residual vibration information Vinf received in step S202 is registered in the database DB, as a specific search target. The specific search target in the database DB is, for example, the residual vibration information Vinf corresponding to the condition information Cinf searched in step S212. For example, the adjustment control portion 210 determines whether or not there is residual vibration similar to the residual vibration indicated by the residual vibration information Vinf received in step S202, in the residual vibration indicated by the residual vibration information Vinf corresponding to the condition information Cinf searched in step S212. The residual vibration similar to the residual vibration indicated by the residual vibration information Vinf is, for example, residual vibration that can be regarded to coincide with the residual vibration indicated by the residual vibration information Vinf when considering a detection error of a noise or the like at a time of detecting the residual vibration. In addition, the residual vibration similar to the residual vibration indicated by the residual vibration information Vinf also includes residual vibration that coincides with the residual vibration indicated by the residual vibration information Vinf. In the following, the residual vibration information Vinf indicating the residual vibration similar to the residual vibration indicated by one residual vibration information Vinf is also referred to as residual vibration information Vinf similar to the one residual vibration information Vinf.

When a result of the determination in step S214 is negative, the adjustment control portion 210 shifts the process to step S220. On the other hand, when the result of the determination in step S214 is affirmative, the adjustment control portion 210 shifts the process to step S216. That is, when the residual vibration information Vinf indicating the residual vibration similar to the residual vibration indicated by the residual vibration information Vinf received in step S202 is searched from the specific search target of the database DB, the process in step S216 is executed.

In step S216, the adjustment control portion 210 acquires the adjustment information Ainf corresponding to the residual vibration information Vinf indicating the specific residual vibration similar to the residual vibration indicated by the residual vibration information Vinf received in step S202 from the database DB. The residual vibration information Vinf indicating the specific residual vibration is the residual vibration information Vinf searched in step S214.

The adjustment information Ainf acquired in step S216 is an example of “specific adjustment information”. For example, the adjustment information Ainf acquired in step S216 is transmitted to the liquid ejecting apparatus 100 in step S240 to be described below. Therefore, in the present embodiment, for example, even when the residual vibration indicated by the residual vibration information Vinf received in step S202 includes a detection error such as a noise, a decrease in accuracy of adjusting the waveform of the drive signal COMa can be prevented.

The adjustment control portion 210 executes the process in step S216, and then shifts the process to step S220.

In step S220, the adjustment control portion 210 analyzes the residual vibration indicated by the residual vibration information Vinf received in step S202. Therefore, for example, as described in FIG. 9, a cycle, an amplitude, an attenuation rate of the amplitude, a phase, and the like of the residual vibration are specified.

Next, in step S222, the adjustment control portion 210 generates at least one piece of adjustment information Ainf for adjusting the waveform of the drive signal COMa based on an analysis result of the residual vibration.

Then, in step S240, the adjustment control portion 210 transmits the adjustment information Ainf to the liquid ejecting apparatus 100 via the communication unit 206. For example, when the process in step S216 is executed, the adjustment control portion 210 transmits the adjustment information Ainf generated in step S222 and the adjustment information Ainf acquired in step S216 to the liquid ejecting apparatus 100 via the communication unit 206. Further, for example, when the process in step S216 is not executed, the adjustment control portion 210 transmits the adjustment information Ainf generated in step S222 to the liquid ejecting apparatus 100 via the communication unit 206. For example, when a plurality of pieces of adjustment information Ainf are generated in step S222, the plurality of pieces of adjustment information Ainf are transmitted from the server 200 to the liquid ejecting apparatus 100. In the same manner, for example, when the plurality of pieces of adjustment information Ainf are acquired in step S216, the plurality of pieces of adjustment information Ainf are transmitted from the server 200 to the liquid ejecting apparatus 100. In the following, the adjustment information Ainf acquired in step S216 and the adjustment information Ainf generated in step S222 may be referred to as the residual vibration information Vinf generated by the head manufacturer without particular distinction.

In this manner, head information necessary for the waveform adjustment is provided from the liquid ejecting apparatus 100 to the server 200 by executing a series of processes in step S110 to step S122 in the liquid ejecting apparatus 100. The head information necessary for the waveform adjustment is the residual vibration information Vinf indicating the waveform of the residual vibration detected by the detection circuit 19, the condition information Cinf related to the use condition of the liquid ejecting head 1, and the like. Further, a series of processes in step S210 to step S240 are executed in the server 200, and thus the adjustment information Ainf is provided from the server 200 to the liquid ejecting apparatus 100. In the following, the series of processes in step S110 to step S122 is also referred to as a head information providing process, and the series of processes in step S210 to step S240 is also referred to as an adjustment information providing process.

By executing the process in step S240, in step S130, the liquid ejecting apparatus 100 receives the residual vibration information Vinf generated by the head manufacturer. That is, in step S130, the reception control portion 44 receives the adjustment information Ainf generated in the head manufacturer, from the server 200 via the communication unit 6.

For example, when the transmission control portion 42 transmits only the residual vibration information Vinf of the residual vibration information Vinf and the condition information Cinf, the reception control portion 44 receives the adjustment information Ainf generated based on the residual vibration information Vinf from the server 200 via the communication unit 6. For example, when the transmission control portion 42 transmits the residual vibration information Vinf and the condition information Cinf, a type of the residual vibration information Vinf received by the reception control portion 44 differs depending on whether or not the specific adjustment information Ainf corresponding to the condition information Cinf is stored in the database DB. For example, when the specific adjustment information Ainf corresponding to the condition information Cinf is not stored in the database DB, the reception control portion 44 receives the adjustment information Ainf generated based on the residual vibration information Vinf from the server 200 via the communication unit 6. In addition, for example, when specific adjustment information Ainf corresponding to the condition information Cinf is stored in the database DB, the reception control portion 44 receives the specific adjustment information Ainf and the adjustment information Ainf generated based on the residual vibration information Vinf from the server 200 via the communication unit 6. Here, in the example illustrated in FIG. 11, the specific adjustment information Ainf is the adjustment information Ainf in which the corresponding condition information Cinf and residual vibration information Vinf are similar to the condition information Cinf and the residual vibration information Vinf transmitted from the transmission control portion 42, respectively.

The reception control portion 44 shifts the process to step S140 after receiving the adjustment information Ainf.

In step S140, the liquid ejecting apparatus 100 accepts a selection as to whether or not to adopt the adjustment information Ainf transmitted from the server 200. For example, the processing control portion 40 displays, on the display device 120, an operation button for selecting whether or not to adopt the adjustment information Ainf as the GUI. In this manner, the processing control portion 40 accepts the selection from the user as to whether or not to adopt the adjustment information Ainf.

When the plurality of pieces of adjustment information Ainf are transmitted from the server 200, the processing control portion 40 accepts the selection from the user as to whether or not to adopt each of the plurality of pieces of adjustment information Ainf in step S140. Further, the processing control portion 40 may present the waveform of the drive signal COMa adjusted based on the adjustment information Ainf to the user in step S140. For example, the processing control portion 40 may cause the display device 120 to display an image indicating the waveform of the drive signal COMa adjusted based on the adjustment information Ainf.

Alternatively, the processing control portion 40 may execute test printing by using the drive signal COMa adjusted based on the adjustment information Ainf in step S140. In this case, the user can select whether or not to adopt the adjustment information Ainf with reference to a result of the test printing.

Next, in step S142, the processing control portion 40 determines whether or not to adopt the adjustment information Ainf based on the reception result in step S140. For example, when adoption of the adjustment information Ainf is selected in step S140, the processing control portion 40 determines that the adjustment information Ainf is to be adopted. Further, when non-adoption of the adjustment information Ainf is selected in step S140, the processing control portion 40 determines that the adjustment information Ainf is not to be adopted.

When a result of the determination in step S142 is affirmative, the operation of the liquid ejecting system SYS for adjusting the waveform of the drive signal COMa is ended. On the other hand, when the result of the determination in step S142 is negative, the processing control portion 40 shifts the process to step S150.

In step S150, the processing control portion 40 causes the display device 120 to display a screen for the waveform adjustment for adjusting the waveform of the drive signal COMa. Therefore, the user can manually adjust the waveform of the drive signal COMa. In this manner, in the present embodiment, the user can select whether to cause the head manufacturer to adjust the waveform of the drive signal COMa or to manually adjust the waveform of the drive signal COMa. As a result, in the present embodiment, usability of the liquid ejecting apparatus 100 can be improved. After the user manually adjusts the waveform of the drive signal COMa, the operation of the liquid ejecting system SYS for adjusting the waveform of the drive signal COMa is ended.

In this manner, in the present embodiment, the head manufacturer can generate the adjustment information Ainf for adjusting the waveform of the drive signal COMa based on the residual vibration detected by the detection circuit 19. As a result, in the present embodiment, even when the waveform of the residual vibration is significantly different from the waveform assumed by the head manufacturer, the waveform of the drive signal COMa for driving the piezoelectric element PZ can be appropriately adjusted.

The operation of the liquid ejecting system SYS is not limited to the example illustrated in FIG. 11. For example, a series of processes in steps S120 and S122 may be executed before a series of processes in steps S110 to S114, or may be executed in parallel with the series of processes in steps S110 to S114. In this case, the adjustment control portion 210 of the server 200 may execute the determination in step S210 after a predetermined time elapses since the reception of the residual vibration information Vinf.

In addition, for example, a part or all of the process in step S100, a series of process in step S140 and S142, and the process in step S150 may be omitted. In an aspect in which the process in step S150 is omitted, when the result of the determination in step S100 is negative or when the result of the determination in step S142 is negative, the processing control portion 40 may end the operation illustrated in FIG. 11 without adjusting the waveform of the drive signal COMa.

In addition, for example, a series of processes in step S110 to step S114, the process in step S200, and a series of processes in step S210 to step S116 may be omitted.

Further, for example, the process in step S214 may be omitted. In this case, for example, in step S216, the adjustment control portion 210 may acquire the adjustment information Ainf corresponding to the condition information Cinf searched in step S212 from the database DB. For example, when an adjustment value indicated by the adjustment information Ainf in the database DB is verified by the head manufacturer for each use condition indicated by the condition information Cinf, it is considered that the appropriate adjustment information Ainf can be acquired even when the process in step S214 is omitted. For example, there is a high possibility that the adjustment information Ainf corresponding to the condition information Cinf searched in step S212 is appropriate. When the process in step S214 is omitted, the specific adjustment information Ainf is, for example, the adjustment information Ainf similar to the condition information Cinf transmitted from the transmission control portion 42, which is the corresponding condition information Cinf.

In addition, for example, the liquid ejecting apparatus 100 may temporarily end the operation for adjusting the waveform of the drive signal COMa after executing the process in step S122. In this case, the server 200 may notify the liquid ejecting apparatus 100 that the adjustment information Ainf is prepared before executing the process in step S240. Then, the liquid ejecting apparatus 100 may restart the operation of adjusting the waveform of the drive signal COMa by requesting transmission of the adjustment information Ainf to the server 200 at any timing after the notification that the adjustment information Ainf is prepared. For example, the server 200 requested to transmit the adjustment information Ainf executes the process in step S240.

Further, for example, as illustrated in FIG. 12, the liquid ejecting system SYS may feed back an adoption result of the adjustment information Ainf generated by a head manufacturer, to the head manufacturer.

FIG. 12 is a diagram illustrating another example of the operation of the liquid ejecting system SYS when adjusting the waveform of the drive signal COMa. An operation illustrated in FIG. 12 has the same manner as the operation illustrated in FIG. 11, except that a series of processes in step S160 to step S164 and a series of processes in step S260 and step S262 are added to the operation illustrated in FIG. 11. In FIG. 12, in order to make the drawing easy to see, the series of processes in step S110 to step S122 are collectively illustrated as a head information providing process, and the series of processes in step S210 to step S240 are collectively illustrated as an adjustment information providing process.

In FIG. 12, the series of processes in step S160 to step S164 and the series of processes in step S260 and step S262 will be described. The control unit 4 of the liquid ejecting apparatus 100 functions as the processing control portion 40 in each of step S160 to step S164. Further, the control unit 204 of the server 200 functions as the adjustment control portion 210 in each of step S260 and step S262.

The process in step S160 is executed when a result of the determination in step S142 is affirmative or after the process in step S150 is executed.

In step S160, the processing control portion 40 accepts a selection as to whether or not to feed back the adoption result of the adjustment information Ainf to the head manufacturer. For example, the processing control portion 40 displays, as a GUI, an operation button for selecting whether or not to feed back the adoption result of the adjustment information Ainf to the head manufacturer, on the display device 120. In this manner, the processing control portion 40 accepts the selection from the user related to whether or not to feed back the adoption result of the adjustment information Ainf to the head manufacturer.

Next, in step S162, the processing control portion 40 determines whether or not to transmit feedback information FBinf including adoption information indicating the adoption result of the adjustment information Ainf to the server 200, based on the reception result in the process in step S160. For example, when transmission of the feedback information FBinf to the server 200 is selected in step S160, the processing control portion 40 determines that the feedback information FBinf is to be transmitted to the server 200. Further, when non-transmission of the feedback information FBinf to the server 200 is selected in step S160, the processing control portion 40 determines that the feedback information FBinf is not to be transmitted to the server 200.

The feedback information FBinf may include reason information indicating a reason for adoption or non-adoption of the adjustment information Ainf, in addition to the adoption information. In this case, for example, in step S160, the processing control portion 40 further accepts a selection from a user as to whether or not to feed back the reason for adoption or non-adoption of the adjustment information Ainf to the head manufacturer.

When a result of the determination in step S162 is affirmative, the processing control portion 40 shifts the process to step S164. On the other hand, when the result of the determination in step S162 is negative, the operation of the liquid ejecting system SYS for adjusting the waveform of the drive signal COMa is ended.

In step S164, the liquid ejecting apparatus 100 transmits the feedback information FBinf to the server 200. For example, the transmission control portion 42 transmits the feedback information FBinf to the server 200 via the communication unit 6.

By executing the process in step S164, in step S260, the server 200 receives the feedback information FBinf. For example, in step S260, the adjustment control portion 210 receives the feedback information FBinf from the liquid ejecting apparatus 100 via the communication unit 206. The adjustment control portion 210 shifts the process to step S262 after receiving the feedback information FBinf.

In step S262, the adjustment control portion 210 updates the database DB based on the feedback information FBinf. For example, the adjustment control portion 210 stores the adoption information indicating the adoption result of the adjustment information Ainf, the adjustment information Ainf, the condition information Cinf, and the residual vibration information Vinf in association with each other in the database DB. When the reason information indicating the reason for adoption or non-adoption of the adjustment information Ainf is included in the feedback information FBinf, in step S262, the adjustment control portion 210 may store the reason information in the database DB in association with the residual vibration information Vinf or the like. By executing the process in step S262, the operation of the liquid ejecting system SYS for adjusting the waveform of the drive signal COMa is ended.

In this manner, in the operation illustrated in FIG. 12, the adoption result of the adjustment information Ainf is fed back to the head manufacturer. Therefore, adjustment accuracy of the waveform of the drive signal COMa adjusted based on the adjustment information Ainf generated by the head manufacturer can be improved. In order to efficiently execute the feedback, a privilege or the like may be granted to the user who has an approval for executing the feedback.

As described above, in the present embodiment, the liquid ejecting system SYS includes the liquid ejecting head 1, the transmission control portion 42, and the reception control portion 44. The liquid ejecting head 1 includes the nozzle N, the piezoelectric element PZ that is driven by the drive signal COM being supplied, the diaphragm 14 that vibrates by driving the piezoelectric element PZ, the pressure chamber CV which is filled with an ink and to which a pressure for ejecting the ink from the nozzle N is applied by the vibration of the diaphragm 14, and the detection circuit 19 that detects residual vibration of the diaphragm 14 after the piezoelectric element PZ is driven. The transmission control portion 42 transmits the residual vibration information Vinf indicating the residual vibration detected by the detection circuit 19 to the server 200. The reception control portion 44 receives the adjustment information Ainf for adjusting a waveform of the drive signal COM, which is generated based on the residual vibration indicated by the residual vibration information Vinf, from the server 200.

In this manner, in the present embodiment, the adjustment information Ainf for adjusting the waveform of the drive signal COM generated based on the residual vibration indicated by the residual vibration information Vinf is provided from the server 200. Therefore, in the present embodiment, even when the manufacturer using the liquid ejecting head 1 does not have the know-how related to the adjustment of the waveform of the drive signal COM, the waveform of the drive signal COMa can be appropriately adjusted based on the adjustment information Ainf provided from the server 200. Therefore, in the present embodiment, the waveform of the drive signal COMa for driving the piezoelectric element PZ can be appropriately and easily determined.

Further, in the present embodiment, the processing control portion 40 may further accept a selection from the user as to whether or not to transmit the condition information Cinf related to a use condition of the liquid ejecting head 1 to the server 200. When transmission of the condition information Cinf to the server 200 is selected, the transmission control portion 42 transmits the condition information Cinf to the server 200. Therefore, in the present aspect, the reception control portion 44 can acquire the adjustment information Ainf based on the use condition of the liquid ejecting head 1 from the server 200. As a result, in the present aspect, the reception control portion 44 can efficiently provide the adjustment information Ainf for appropriately adjusting the waveform of the drive signal COMa. Further, in the present embodiment, since the user can select whether or not to transmit the condition information Cinf to the server 200, the condition information Cinf can be prevented from being transmitted to the server 200 against the intention of the user.

Further, in the present embodiment, the condition information Cinf may include information on a type of ink. In this case, the adjustment information Ainf according to the type of the ink can be efficiently provided to the reception control portion 44.

Further, in the present embodiment, the condition information Cinf may include information on a temperature. In this case, the adjustment information Ainf according to the temperature of the ink or the like in the liquid ejecting head 1 can be efficiently provided to the reception control portion 44.

In addition, in the present embodiment, the condition information Cinf may include information on a pressure. In this case, the adjustment information Ainf according to the pressure of the pressure chamber CV or the like can be efficiently provided to the reception control portion 44.

In the present embodiment, the reception control portion 44 may receive the specific adjustment information Ainf from the server 200 when the transmission control portion 42 transmits the residual vibration information Vinf and the condition information Cinf and the specific adjustment information Ainf corresponding to the condition information Cinf is stored in the database DB referred to by the server 200. In this case, even when the residual vibration indicated by the residual vibration information Vinf transmitted by the transmission control portion 42 includes a detection error such as a noise, a decrease in accuracy of adjusting the waveform of the drive signal COMa can be prevented, by using the specific adjustment information Ainf.

Further, in the present embodiment, the processing control portion 40 that accepts the selection from the user as to whether or not to adopt the adjustment information Ainf may be further provided. The transmission control portion 42 transmits adoption information indicating an adoption result of the adjustment information Ainf to the server 200. In this case, since the adoption result of the adjustment information Ainf and the like is fed back to the server 200, the adjustment accuracy of the waveform of the drive signal COMa adjusted by using the adjustment information Ainf generated based on the residual vibration information Vinf transmitted to the server 200 can be improved.

In the present embodiment, the server 200 may store the adoption information in the database DB in association with the residual vibration information Vinf. In this case, since the adoption results of the plurality of pieces of adjustment information Ainf are accumulated in the database DB, the adjustment accuracy of the waveform of the drive signal COMa adjusted by using the adjustment information Ainf transmitted from the server 200 can be improved.

In the present embodiment, the liquid ejecting head 1 has the plurality of nozzles N. The transmission control portion 42 may transmit information indicating only the residual vibration corresponding to one nozzle N representing the plurality of nozzles N to the server 200, as the residual vibration information Vinf. In this case, since it is not necessary to detect residual vibration in the plurality of nozzles N to adjust the waveform of the drive signal COMa, the detection of the residual vibration can be prevented from being complicated. The adjustment of the waveform of the drive signal COMa is defined for each liquid ejecting head 1. Therefore, even when the waveform of the drive signal COMa is adjusted by using the adjustment information Ainf generated based on the residual vibration corresponding to one nozzle N, the waveform of the drive signal COMa can be appropriately adjusted.

### 2. Modification Example

Each embodiment above can be variously modified. A specific aspect of the modification will be described below. Two or more aspects selected in any manner from the following examples can be appropriately combined with each other within a range not inconsistent with each other. In addition, in the modification examples described below, elements having the same effects and functions as those of the embodiment will be given the reference numerals used in the description above, and each detailed description thereof will be appropriately omitted.

### First Modification Example

In the embodiment described above, the server 200 may determine an ejection state of the nozzle N of the liquid ejecting head 1. For example, the server 200 may determine the ejection state of each of the plurality of nozzles N based on residual vibration corresponding to each nozzle N. In this case, the detection circuit 19 of the liquid ejecting head 1 individually detects the residual vibration of the plurality of ejecting portions D corresponding to the plurality of nozzles N, for example. The transmission control portion 42 individually transmits the residual vibration information Vinf indicating the residual vibration of each of the plurality of ejecting portions D to the server 200 via the communication unit 6. Therefore, in the present modification example, for example, when a waveform of the drive signal COMa is adjusted, residual vibration is detected for the plurality of nozzles N only when the residual vibration corresponding to one nozzle N representing the plurality of nozzles N is detected and the ejection state of the nozzle N is determined.

As described above, also in the present modification example, the same effect as the effect of the embodiment and modification example described above can be obtained. Further, in the present modification example, the server 200 can determine the ejection state of the plurality of nozzles N.

### Second Modification Example

In the embodiment and the modification example described above, when the adjustment information Ainf is not adopted, the adjustment information Ainf may be repeatedly generated by the head manufacturer. For example, when the result of the determination in step S142 is negative, the processing control portion 40 of the liquid ejecting head 1 may cause the server 200 to execute the adjustment information providing process, which is a series of processes in step S120 to step S240, again. In this case, the transmission control portion 42 of the liquid ejecting head 1 may transmit information indicating a result of test printing with the drive signal COMa adjusted based on the adjustment information Ainf for non-adoption to the server 200 via the communication unit 6. Further, the transmission control portion 42 may transmit the condition information Cinf indicating a use condition of the liquid ejecting head 1 at a time of the test printing to the server 200 via the communication unit 6. Alternatively, when the result of the determination in step S142 is negative, the processing control portion 40 of the liquid ejecting head 1 may return the process to step S100. As described above, also in the present modification example, the same effect as the effect of the embodiment and modification example described above can be obtained. Further, in the present modification example, since the adjustment information providing process can be repeatedly executed on the server 200, a possibility that the appropriate adjustment information Ainf is provided from the server 200 can be increased.

### Third Modification Example

In the embodiment and the modification example described above, a case is described as an example in which one piezoelectric element PZ, one pressure chamber CV, and one nozzle N are provided for one ejecting portion D, and the present disclosure is not limited to such an aspect. For example, one ejecting portion D may have two piezoelectric elements PZ, two pressure chambers CV, and one nozzle N. As described above, also in the present modification example, the same effect as the effect of the embodiment and modification example described above can be obtained.

### Fourth Modification Example

In the embodiment and the modification example described above, the liquid ejecting apparatus 100 having a serial method in which the carriage 91 at which the liquid ejecting head 1 is mounted is reciprocated in the X-axis direction is described, and the present disclosure is not limited to such an aspect. For example, the liquid ejecting apparatus 100 may have a line method liquid ejecting apparatus in which the plurality of nozzles N are distributed over an entire width of the medium PP. As described above, also in the present modification example, the same effect as the effect of the embodiment and modification example described above can be obtained.

### Fifth Modification Example

The liquid ejecting apparatus 100 described in the embodiment and the modification example described above can be adopted in various devices such as a facsimile machine and a copying machine, in addition to a device dedicated to printing. Moreover, the application of the liquid ejecting apparatus of the present disclosure is not limited to printing. For example, a liquid ejecting apparatus that ejects a solution of a coloring material is used as a manufacturing device that forms a color filter of a liquid crystal display device. In addition, a liquid ejecting apparatus that ejects a solution of a conductive material is used as a manufacturing apparatus that forms a wire or an electrode of a wiring substrate. As described above, also in the present modification example, the same effect as the effect of the embodiment and modification example described above can be obtained.

### 3. Appendixes

From the embodiments described above, for example, the following configuration can be ascertained.

According to Aspect 1 that is a preferred aspect, there is provided a liquid ejecting system including: a liquid ejecting head; a transmission control portion; and a reception control portion, in which the liquid ejecting head includes a nozzle, a piezoelectric element that is driven by a drive signal being supplied, a diaphragm that vibrates by driving the piezoelectric element, a pressure chamber which is filled with a liquid and to which a pressure for ejecting the liquid from the nozzle is applied by the vibration of the diaphragm, and a detection portion that detects residual vibration of the diaphragm after the piezoelectric element is driven, the transmission control portion transmits residual vibration information indicating the residual vibration detected by the detection portion to a server, and the reception control portion receives adjustment information for adjusting a waveform of the drive signal, which is generated based on the residual vibration indicated by the residual vibration information, from the server.

With Aspect 1, the waveform of the drive signal can be appropriately and easily adjusted, based on the adjustment information provided from the server. That is, in the present aspect, the waveform of the drive signal for driving the piezoelectric element can be appropriately and easily determined.

The liquid ejecting system according to according to Aspect 2 that is a specific example of Aspect 1, further includes: an acceptance portion that accepts a selection from a user as to whether or not to transmit condition information on a use condition of the liquid ejecting head to the server, in which when transmission of the condition information to the server is selected, the transmission control portion transmits the condition information to the server.

With Aspect 2, the adjustment information based on the use condition of the liquid ejecting head can be acquired from the server. Further, in the present aspect, since the user can select whether or not to transmit the condition information to the server, the condition information can be prevented from being transmitted to the server against the intention of the user.

In the liquid ejecting system according to Aspect 3 that is a specific example of Aspect 2, the condition information includes information on a type of liquid.

With Aspect 3, the adjustment information according to the type of liquid can be efficiently provided to the reception control portion.

In the liquid ejecting system according to Aspect 4 that is a specific example of Aspect 2 or 3, the condition information includes information on a temperature.

With Aspect 4, the adjustment information according to the temperature of the liquid in the liquid ejecting head or the like can be efficiently provided to the reception control portion.

In the liquid ejecting system according to Aspect 5 that is a specific example of any one of Aspects 2 to 4, the condition information includes information on a pressure.

With Aspect 5, the adjustment information according to the pressure of the pressure chamber or the like can be efficiently provided to the reception control portion.

In the liquid ejecting system according to Aspect 6 that is a specific example of any one of Aspects 2 to 5, when the transmission control portion transmits the residual vibration information and the condition information and specific adjustment information corresponding to the condition information is stored in a database referred to by the server, the reception control portion receives the specific adjustment information from the server. With Aspect 6, even when the residual vibration indicated by the residual vibration information transmitted by the transmission control portion includes a detection error such as a noise, a decrease in accuracy of adjusting the waveform of the drive signal can be prevented by using the specific adjustment information.

In the liquid ejecting system according to Aspect 7 that is a specific example of Aspect 6, when the transmission control portion transmits only the residual vibration information of the residual vibration information and the condition information, the reception control portion receives the adjustment information generated based on the residual vibration information, from the server.

With Aspect 7 as well, the decrease in accuracy of adjusting the waveform of the drive signal can be prevented.

The liquid ejecting system according to Aspect 8 that is a specific example of any one of Aspects 1 to 7, further includes: an acceptance portion that accepts a selection from a user as to whether or not to adopt the adjustment information, in which the transmission control portion transmits adoption information indicating an adoption result of the adjustment information to the server.

With Aspect 8, since the adoption result of the adjustment information is fed back to the server, the adjustment accuracy of the waveform of the drive signal adjusted by using the adjustment information generated based on the residual vibration information transmitted to the server can be improved.

In the liquid ejecting system according to Aspect 9 that is a specific example of Aspect 8, the server stores the adoption information in a storage portion in association with the residual vibration information.

With Aspect 9, since adoption results of a plurality of pieces of adjustment information are accumulated in the storage portion, the adjustment accuracy of the waveform of the drive signal adjusted by using the adjustment information transmitted from the server can be improved.

In the liquid ejecting system according to Aspect 10 that is a specific example of any one of Aspects 1 to 9, in which the liquid ejecting head has a plurality of the nozzles, and the transmission control portion transmits information indicating only the residual vibration corresponding to one nozzle representing the plurality of nozzles to the server, as the residual vibration information.

With Aspect 10, when the residual vibration is detected to adjust the waveform of the drive signal, the detection of the residual vibration can be prevented from being complicated.

In the liquid ejecting system according to Aspect 11 that is a specific example of Aspect 10, when the server determines an ejection state of the plurality of nozzles, the detection portion individually detects residual vibration corresponding to the plurality of nozzles, and the transmission control portion individually transmits the residual vibration information indicating the residual vibration corresponding to each of the plurality of nozzles to the server.

With Aspect 11, the server can determine the ejection state of the plurality of nozzles.

According to Aspect 12 that is another preferred aspect, there is provided a liquid ejecting system including: a communication device that performs communication with a server; a liquid ejecting head; a transmission control portion; and a reception control portion, in which the liquid ejecting head includes a nozzle, a piezoelectric element that is driven by a drive signal being supplied, a diaphragm that vibrates by driving the piezoelectric element, a pressure chamber which is filled with a liquid and to which a pressure for ejecting the liquid from the nozzle is applied by the vibration of the diaphragm, and a detection portion that detects residual vibration of the diaphragm after the piezoelectric element is driven, the transmission control portion transmits residual vibration information indicating the residual vibration detected by the detection portion to the server via the communication device, and the reception control portion receives adjustment information for adjusting a waveform of the drive signal, which is generated based on the residual vibration indicated by the residual vibration information, from the server via the communication device.

In Aspect 12 as well, the waveform of the drive signal for driving the piezoelectric element can be appropriately and easily determined.

According to Aspect 13 that is still another preferred aspect, there is provided a liquid ejecting apparatus including: a liquid ejecting head; a transmission control portion; and a reception control portion, in which the liquid ejecting head includes a nozzle, a piezoelectric element that is driven by a drive signal being supplied, a diaphragm that vibrates by driving the piezoelectric element, a pressure chamber which is filled with a liquid and to which a pressure for ejecting the liquid from the nozzle is applied by the vibration of the diaphragm, and a detection portion that detects residual vibration of the diaphragm after the piezoelectric element is driven, the transmission control portion transmits residual vibration information indicating the residual vibration detected by the detection portion to a server, and the reception control portion receives adjustment information for adjusting a waveform of the drive signal, which is generated based on the residual vibration indicated by the residual vibration information, from the server.

In Aspect 13 as well, the waveform of the drive signal for driving the piezoelectric element can be appropriately and easily determined.

What is claimed is:

1. A liquid ejecting system comprising:
a liquid ejecting head;
a transmission control portion; and
a reception control portion, wherein
the liquid ejecting head includes
a nozzle,
a piezoelectric element that is driven by a drive signal being supplied,
a diaphragm that vibrates by driving the piezoelectric element,
a pressure chamber which is filled with a liquid and to which a pressure for ejecting the liquid from the nozzle is applied by the vibration of the diaphragm, and
a detection portion that detects residual vibration of the diaphragm after the piezoelectric element is driven,
the transmission control portion transmits residual vibration information indicating the residual vibration detected by the detection portion to a server, and
the reception control portion receives adjustment information for adjusting a waveform of the drive signal, which is generated based on the residual vibration indicated by the residual vibration information, from the server.

2. The liquid ejecting system according to claim 1, further comprising:
an acceptance portion that accepts a selection from a user as to whether or not to transmit condition information on a use condition of the liquid ejecting head to the server, wherein
when transmission of the condition information to the server is selected, the transmission control portion transmits the condition information to the server.

3. The liquid ejecting system according to claim 2, wherein
the condition information includes information on a type of liquid.

4. The liquid ejecting system according to claim 2, wherein
the condition information includes information on a temperature.

5. The liquid ejecting system according to claim 2, wherein
the condition information includes information on a pressure.

6. The liquid ejecting system according to claim 2, wherein
when the transmission control portion transmits the residual vibration information and the condition information and specific adjustment information corresponding to the condition information is stored in a database referred to by the server, the reception control portion receives the specific adjustment information from the server.

7. The liquid ejecting system according to claim 1, further comprising:
an acceptance portion that accepts a selection from a user as to whether or not to adopt the adjustment information, wherein
the transmission control portion transmits adoption information indicating an adoption result of the adjustment information to the server.

8. The liquid ejecting system according to claim 7, wherein
the server stores the adoption information in a storage portion in association with the residual vibration information.

9. The liquid ejecting system according to claim 1, wherein
the liquid ejecting head has a plurality of the nozzles, and
the transmission control portion transmits information indicating only the residual vibration corresponding to one nozzle representing the plurality of nozzles to the server, as the residual vibration information.
